(19) United States
(12) Patent Application Publication
(10) Pub. No.: US 2018/0143932 A1
(43) Pub. Date: May 24, 2018

(54) APPARATUSES AND METHODS TO SPAWN MULTIPLE VIRTUAL SERIAL BUS HUB INSTANCES ON A SAME PHYSICAL SERIAL BUS HUB

(71) Applicant: Intel Corporation, Santa Clara, CA (US)

(72) Inventors: SEAN LAWLESS, Santa Cruz, CA (US); ANDREW D. HENROID, Portland, OR (US)

(21) Appl. No.: 15/358,112

(22) Filed: Nov. 21, 2016

(51) Int. Cl. G06F 13/40; G06F 13/42

(52) U.S. Cl. CPC G06F 13/4068; G06F 13/4282

(57) ABSTRACT

Methods and apparatuses relating to circuitry to spawn multiple virtual serial bus hub instances on a same physical serial bus hub are described. In one embodiment, an apparatus includes a serial bus hub to electrically couple a plurality of hosts and a plurality of devices, and a circuit to spawn a first virtual hub instance that is bound to a first host of the plurality of hosts and a first device of the plurality of devices, and spawn a concurrently usable, second virtual hub instance that is bound to a second host of the plurality of hosts and a second device of the plurality of devices.

### TECHNICAL FIELD

The disclosure relates generally to electronics, and, more specifically, an embodiment of the disclosure relates to circuitry to spawn multiple virtual serial bus hub instances on a same physical serial bus hub.

### BACKGROUND

Electronics (e.g., computer systems) generally employ one or more electrical connections to facilitate the transmittal of data (e.g., communication) between devices, such as between a computing system and a (e.g., external) peripheral.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a schematic diagram of a system including a plurality of hosts coupled to a plurality of devices via a serial bus hub according to embodiments of the disclosure.

FIG. 2 illustrates a schematic diagram of a system including a plurality of hosts coupled wirelessly to a plurality of devices via a serial bus hub according to embodiments of the disclosure.

FIG. 3 illustrates a schematic diagram of a system including a plurality of hosts coupled with a wired connection to a plurality of devices via a serial bus hub according to embodiments of the disclosure.

FIG. 4 illustrates a flow diagram of the states of a virtual hub instance according to embodiments of the disclosure.

FIG. 5 illustrates a flow diagram of spawning multiple virtual serial bus hub instances on a same physical serial bus hub according to embodiments of the disclosure.

FIG. 6 illustrates a perspective view of a serial bus receptacle according to embodiments of the disclosure.

FIG. 7 illustrates a schematic diagram of the pins of a serial bus receptacle according to embodiments of the disclosure.

FIG. 8 illustrates a perspective view of a serial bus plug according to embodiments of the disclosure.

FIG. 9 illustrates a schematic diagram of the pins of a serial bus plug according to embodiments of the disclosure.

FIG. 10 illustrates a computing system including a peripheral component interconnect express (PCIe) compliant architecture according to embodiments of the disclosure.

FIG. 11 illustrates a PCIe compliant interconnect architecture including a layered stack according to embodiments of the disclosure.

FIG. 12 illustrates a PCIe compliant request or packet to be generated or received within an interconnect architecture according to embodiments of the disclosure.

FIG. 13 illustrates a transmitter and receiver pair for a PCIe compliant interconnect architecture according to embodiments of the disclosure.

FIG. 14 illustrates a computing system on a chip according to embodiments of the disclosure.

FIG. 15 illustrates an embodiment of a block diagram for a computing system.

FIG. 16 illustrates another embodiment of a block diagram for a computing system.

FIG. 17 illustrates another embodiment of a block diagram for a computing system.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Electronics (e.g., computing systems) generally employ one or more electrical couplings (e.g., wired or wireless connections) to facilitate the transmission and reception of data (e.g., communication) between devices, such as, but not limited to, between a computing system (e.g., a computer including a hardware processor) and a (e.g., external) peripheral. Non-limiting examples of peripherals are a keyboard, mouse, external storage device (e.g., hard disk drive), and mobile device (e.g., smartphone or tablet).

Certain electrical couplings (e.g., connections) include parallel conductors (e.g., parallel wires or other electrically conductive paths). One embodiment of an electrical connection is a bus. One embodiment of a bus is a multiple conductor bus, for example, where the conductors (e.g., wires) allow parallel (e.g., concurrent) transmittal of data thereon. The term electrical coupling may generally refer to one or more connections, communication lines and/or interfaces, shared connections, and/or point-to-point connections, which may be connected by appropriate bridges, hubs, adapters, and/or controllers. A serial bus (e.g., serial bus architecture) may generally refer to a (e.g., shared) communication channel that transmits data one bit after another (e.g., sequentially), for example, over a (e.g., each) channel (e.g., single wire or fiber).

The phrase Universal Serial Bus (USB) generally refers to a specification(s) for a serial bus that supports the transmission and reception of data (e.g., and power and/or control) between a downstream facing port (e.g., a host) and an upstream facing port (e.g., device), for example, through one or more hubs there between. The phrase Media Agnostic USB (MA-USB) generally refers to a specification(s) to enable communication using a Universal Serial Bus (USB) specification to be performed over a wide range of physical communication media, e.g., including WiFi and WiGig wireless networks. In one embodiment, MA-USB allows communications for wireless devices (e.g., docking stations) without utilizing or needing a physical USB port or other physical connection. In one embodiment, MA-USB enables wireless gigabit transfer rates using existing USB circuitry, e.g., where the device is presented to a host as a USB device (e.g., compliant with a USB specification) even though that device is not connected to the host via a USB cable. A MA-USB Protocol Adaptation Layer (PAL) may be utilized to enable transport of USB data over media other than a physical USB cable, for example, over wireless connections (e.g., Wi-Fi or WiGig links), or non-USB wired connections (e.g., according to an Ethernet standard(s)). In a wireless embodiment, MA-USB PAL may interface directly with a radio, for example, to replace the network layer in an Open Systems Interconnection (OSI) model or be an Internet Protocol (IP) application, e.g., interfacing with the Transmission Control Protocol (TCP) and IP (TCP/IP) protocols (e.g., stack of layers).

In one (e.g., USB) embodiment, one host may only use one (e.g., USB) device at a time, for example, such that sharing a (e.g., USB) device includes unplugging the device from one host and plugging it into another host. In one embodiment, a device (e.g., an external (e.g., USB) hub or a keyboard, video and mouse (KVM) switch) allows the switching of a connection between a particular host and a particular device, but at no point may the (e.g., USB) devices be utilized by respective hosts at the same time. In one embodiment, a plug of a USB cable is to be physically moved from being connected between hosts and/or hubs. In one embodiment, multiple physical hubs are shared with different hosts, and requires the user to physically change a connection (e.g., move the plug to a different device receptacle) to a (e.g., USB) device.

Certain embodiments herein architect a (e.g., MA-USB) hub so that devices may be used by different (e.g., MA-USB) virtual hubs simultaneously. In one embodiment, each (e.g., MA-USB) host connection utilizes a unique network socket (e.g., media access control (MAC) address or IP address), for example, and attaches that socket to a unique subset of the available (e.g., USB) devices.

Certain embodiments herein provide multiple virtual serial bus hub instances that are usable simultaneously on a same physical serial bus hub. Certain embodiments herein provide for virtual (e.g., MA-USB) hub instances to partition a physical (e.g., USB) hub such that each of the instances (e.g., logical unit) are simultaneously shared with a respective host of a plurality of different hosts. Certain embodiments herein allow a (e.g., USB) device to be wirelessly shared across different hosts. Certain embodiments herein allow for virtualization of wired USB hubs in order to share devices on the same physical hub with multiple hosts.

Certain embodiments herein allow concurrent use of a first hub and device pair with a second hub and device pair, e.g., via a hub that allows concurrent use, e.g., not merely a connection shared first with one host and device, and then a connection shared next with another host and device. Certain embodiments herein restrict or prevent all devices on a hub from being shared with each host connected to that hub, e.g., where only one host at a time may use the devices electrically coupled to the hub.

Certain embodiments herein provide for the partitioning of different physical (e.g., USB) devices into a subset of those devices, for example, where each subset is shared with a single, different host (e.g., via a virtual MA-USB hub or a physical upstream port). In one embodiment, each host is bound to a particular device or set of devices, e.g., where those devices are usable exclusively by that different host while they are bound. In this embodiment, each host may enumerate the unique upstream facing (e.g., device) ports assigned to it and not affect or be affected by other hosts already connected (e.g., and using) different downstream facing (e.g., host) ports.

Certain embodiments herein allow the sharing of (e.g., USB) devices with different hosts simultaneously, e.g., both when utilizing MA-USB as well as when applied to USB hosts physically connected to USB hubs. For example, a computing system (e.g., personal computer (PC)) may be a docking station for a mobile device (e.g., tablet or smart phone) when connected to the (e.g., USB) hub, e.g., over MA-USB wireless connection or a physical (e.g., Type C, etc.) connection. In one embodiment, some USB ports of (or devices connected to) the hub may remain connected to a computing system while others are shared with a docked mobile device. Certain embodiments herein allow the on demand sharing of (e.g., USB) devices. Certain embodiments herein avoid plugging a micro USB adapter and hub into a device (e.g., mobile phone or tablet) to utilize USB devices. Certain embodiments herein allow for a user's device to connect to and use any USB device on a connected network, for example, computing (e.g., desktop) systems may share their USB devices with other devices (e.g., handheld or Internet of Things (IoT) systems), e.g., over WiFi. In one embodiment, one host is a wireless device with no or limited (e.g., a single) USB ports and a hub is a powered device with physical USB ports, for example, a hub within a computing (e.g., desktop) system to share any or all of its connected USB devices with any combination of wireless devices (e.g., hosts) on the same network.

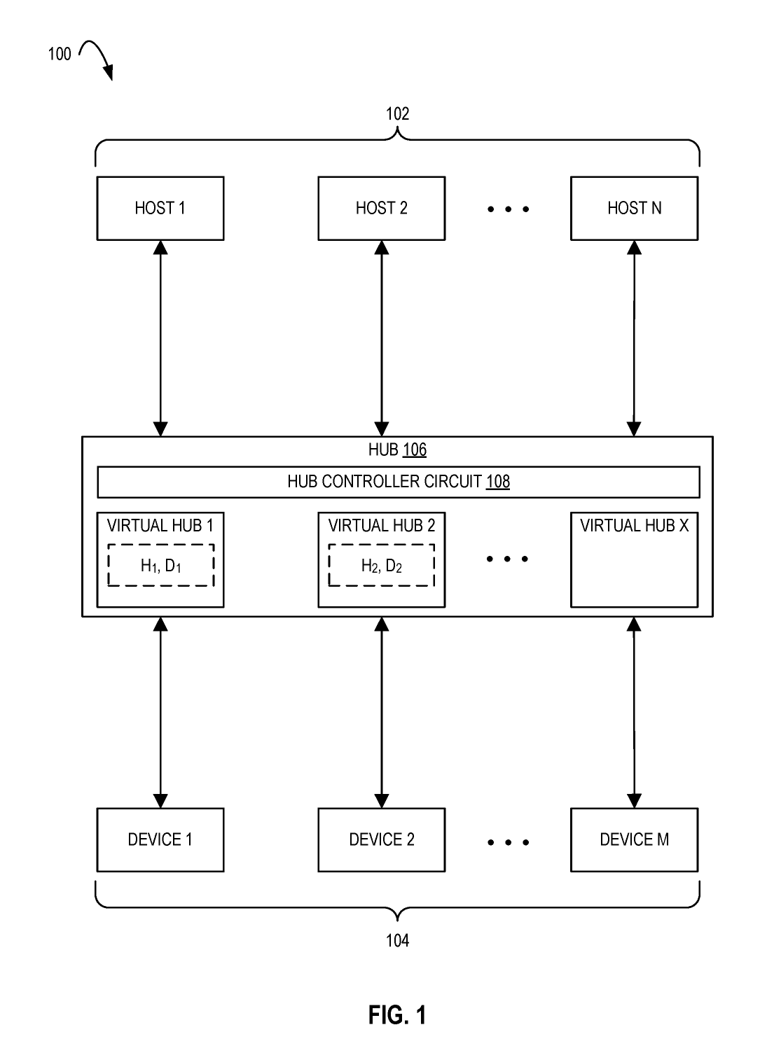

FIG. 1 illustrates a schematic diagram of a system 100 including a plurality of hosts 102 coupled to a plurality of devices 104 via a serial bus hub 106 according to embodiments of the disclosure. In one embodiment, the plurality of hosts 102 is any number N, e.g., 2 or more. In one embodiment, the plurality of devices 104 is any number M, e.g., 2 or more or 3 of more. M may be equal to N or not equal to N.

Certain embodiments herein provide for a subset of the plurality of hosts to connect to a subset of a plurality of devices electrically coupled to the hosts, for example, coupled via a hub. A first virtual hub instance may include (e.g., be bound to) a subset of the plurality of hosts and a subset of a plurality of devices that are allowed to transmit data therebetween, for example, and not to a host and/or device that is not bound to the first virtual hub instance. As one example, first virtual hub (1) instance (schematically depicted within hub 106) may be bound to host 1 (H₁) and device 1 (D₁). A second virtual hub instance may include (e.g., be bound to) a different subset of the plurality of hosts and a different subset of a plurality of devices that are allowed to transmit data therebetween (e.g., concurrently yet separately from the transmittal of data within the first virtual hub instance), for example, and not to a host and/or device that is not bound to the second virtual hub instance. As one example, second virtual hub (2) instance (schematically depicted within hub 106) may be bound to host 2 (H₂) and device 2 (D₂). In one embodiment, any plurality of virtual hub instance may be utilized, e.g., the number X. X may be equal to N number of hosts.

A host may include (e.g., USB) serial bus circuitry (e.g., including a controller). A host may include (e.g., MA-USB) circuitry (e.g., including circuitry to control a host PAL) to allow a link between the serial bus circuitry and a (e.g., non-USB) transceiver (e.g., radio) of the host. A device may include (e.g., USB) serial bus circuitry (e.g., including a controller). A device may include (e.g., MA-USB) circuitry (e.g., including circuitry to control a device PAL) to allow a link between the serial bus circuitry and a (e.g., non-USB) transceiver (e.g., radio) of the device. A hub may include (e.g., USB) serial bus circuitry (e.g., including a hub controller circuit). A hub may include (e.g., MA-USB) circuitry (e.g., to emulate a USB connection) to allow a link between a host and device each electrically coupled to the hub, e.g., electrically coupled over a non-USB connection. In one embodiment, a MA-USB hub includes circuitry to manage the attachment and removal of wired USB devices on downstream facing ports, scheduling and completion of USB transactions targeting USB devices connected to the downstream facing USB ports, and/or USB address assignment. In one embodiment, a MA-USB hub provides power to attached USB devices.

A circuit (e.g., within hub, host, and/or device) may spawn a virtual hub instance, e.g., virtual hub 1, 2, . . . X. In one embodiment, the circuit is within hub 106. In embodiment, the circuit is within a link control management circuit of the hub. In one embodiment, the circuit is (e.g., USB) hub controller circuit 108. A hub controller circuit may control the data routing from a host to one of multiple devices and/or the data transfer rate (speed) of multiple data transfer rates supported by the hub. In one embodiment, a circuit to spawn a virtual hub instance is to detect a host and a device and bind them together, e.g., such that the host (e.g., a particular downstream facing port thereof) and the device (e.g., a particular upstream facing port thereof) are to (e.g., only) transmit data to and/or from each other. A circuit to spawn a virtual hub instance may detect a second host and second device (e.g., device that is available for use and not bound to another virtual hub instance) and bind them together, e.g., such that the second host (e.g., a particular downstream facing port thereof) and the second device (e.g., a particular upstream facing port thereof) are to (e.g., only) transmit data to and/or from each other. A circuit to spawn a virtual hub instance may detect an additional device and bind it to a new or existing virtual hub instance. For example, a third device may be electrically coupled to hub 106 and the third device may be bound to first virtual hub instance (1), e.g., at the request of a host bound to the first virtual hub instance. In one embodiment, a host specifies to the circuit a device or subset of devices that it desires to access and the circuit then binds that device or subset of devices to a virtual hub instance that includes the host. In one embodiment, a circuit (e.g., a virtual hub instances management circuit) creates and/or manages each virtual hub instance, for example, the circuit may read an identification indication (e.g., number) for each device and host to be bound together. In one embodiment, the circuit (e.g., the virtual hub instances management circuit) is to permit or deny access between a host and a device based on the identification indication for each matching the entries in a data structure (e.g., table) that indicates the devices and hosts that are bound together. In one embodiment, there are multiple physical hubs where each physical hub represents a virtual hub, e.g., so there is a distinct (e.g., USB) physical hub for each virtual hub instance.

In one embodiment, a reset request from a host (e.g., during enumeration) is to cause a reset of a first virtual hub instance that binds the host, and not a reset of another virtual hub instance. In one embodiment, a reset request from the host is to not cause a reset of the serial bus hub itself. In one embodiment, a reset request from the host is to cause a reset of the first device (that is bound to the host via a first virtual hub instance) and not a reset of another device (e.g., bound to a different virtual hub instance). In one embodiment, the circuit is to present, to a subsequent host electrically coupled to the serial bus hub, a list of the plurality of devices that are not bound to a current virtual hub instance. A virtual hub instance may bind a host and a device or devices according to a Universal Serial Bus (USB) specification.

In one embodiment, a (e.g., USB) hub and downstream devices are first enumerated by a (e.g., primary) upstream host and a compilation (e.g., list in a data structure) of available devices that may be virtualized is generated, e.g., and may then be shared with subsequent (e.g., USB) host(s). In one embodiment, this advertising of available devices (e.g., specific port of ports thereof) ports is performed using Wireless Serial Bus (WSB) specification (e.g., if MA-USB is being used), or an (e.g., GUI) interface to configure a physical upstream port to bind to specific downstream ports. In one embodiment, each (e.g., USB) host specifies the desired subset of (e.g., USB) devices to connect to and then a virtual hub instance is spawned that is bound to only those devices and/or ports. In one embodiment with a physical host connection to a device, the downstream facing port of the host is set (e.g., by the shared (USB) hub) to attach to a subset of the available upstream facing devices and/or ports. In one embodiment, during host enumeration (e.g., of a virtual hub or physical hub subset), the reset of the hub is faked to avoid other resetting (e.g., established) connections of other hosts connected to the same hub. In one embodiment, a real reset of the device(s) that are bound to a virtual hub are to be performed. In one embodiment, the circuitry transferring a device from one virtual hub instance to another virtual hub instance results in another device reset during enumeration, e.g., but will not reset the physical hub.

Note that a single headed arrow herein may not require one-way communication, for example, it may indicate two-way communication (e.g., to and from that component). Any or all combinations of communications paths may be utilized in certain embodiments herein.

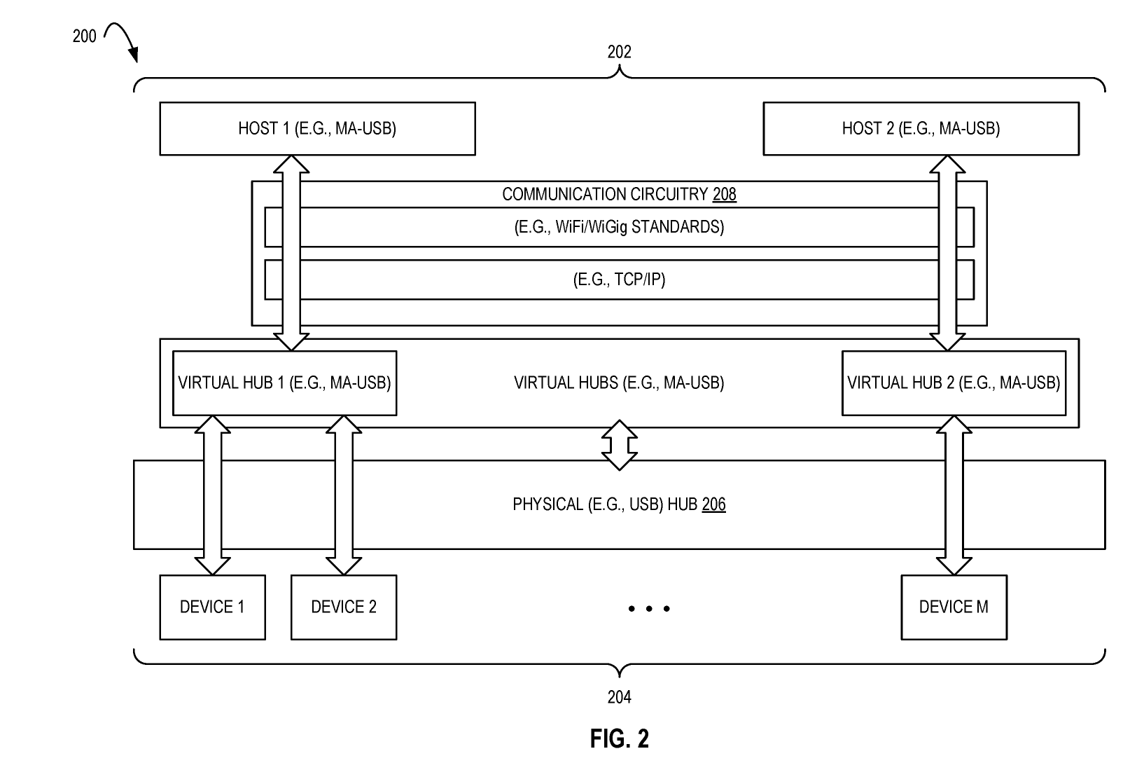

FIG. 2 illustrates a schematic diagram of a system 200 including a plurality of hosts 202 coupled wirelessly to a plurality of devices 204 via a serial bus hub 206 according to embodiments of the disclosure. In one embodiment, each device connects wirelessly to a hub and/or each host connects wirelessly to the hub. In certain embodiments, a mixture of wired and wireless connections may be utilized, for example, some or all devices may wirelessly (or wired) couple to a hub and some or all hosts may wired (or wirelessly) couple to the hub. In one embodiment, a hub is a component of a computing system, e.g., and not a component of a device (or its upstream facing port).

Plurality of hosts 202 may include one or more MA-USB hosts. Communication circuitry 208 may provide for a (e.g., data) channel or channels of communication between components, for example, between a host and a hub 206, e.g., between a host and a virtual hub instance. In one embodiment, communication circuitry 208 communicates according to the Wi-Fi standard(s) and/or WiGig standard(s). In one embodiment, communication circuitry communicates according to TCP/IP protocol(s).

In certain embodiments, circuitry (e.g., in physical (e.g., USB) hub 206) spawns one or more virtual hub instances. In the depicted embodiment, hub 206 has spawned a first virtual (e.g., MA-USB) hub instance binding host 1 to device 1 and device 2, and spawned a second virtual (e.g., MA-USB) hub instance binding host 2 to device M, e.g., M may be the number 3.

In one embodiment, a circuit (e.g., as part of a host or hub) is to detect an (e.g., USB) port connect event, and the circuit is then to create a new context (e.g., a device object) for the device that is connected downstream of the port. In one embodiment, this device object is populated with information extracted from the device (e.g., descriptors, etc.) and may be used by the host to store the state of the device. In certain embodiments, a circuit (e.g., as part of a hub) is to detect an event (e.g., the port connect event and/or the new context) and generate a virtual hub instance for the host and device(s) that are to be electrically coupled to provide for a data transfer (e.g., payload data in addition or alternatively to control data). This may occur for each additional host and/or (unused) device that appears (e.g., is electrically coupled) to the hub. For example, the (e.g., virtual host manager) circuit may bind host 1 to device 1 and 2 in a first virtual hub instance and may bind host 2 to device M (e.g., 3) (or a plurality of devices) in a second virtual hub instance. In one embodiment, device 1 and device 2 may be utilized by host 1 and not host 2 and/or device M (e.g., 3) may be utilized by host 2 and not host 1. In one embodiment, host and device(s) on a first virtual hub instance are concurrently (e.g., simultaneously) usable with a second (e.g., any other) virtual hub instance, for example, with each virtual hub instance for all hosts and devices on a single (e.g., physical) hub. In one embodiment, data is actively transmitted in each virtual hub instance without being interleaved. In one embodiment, the (e.g., MA-USB) virtual hub uses the physical (e.g., USB) hub to send and receive data. The arrow in FIG. 2 between the virtual hubs (e.g., not the virtual hub instances) and physical hub 206 illustrates an embodiment where the (e.g., MA-USB) virtual hub controls the physical hub in order to exchange data, for example, the (e.g., MA-USB) virtual hub being dependent upon the physical (e.g., USB) hub to perform the actual (e.g., USB) communication with the physical (e.g., USB) devices (ports).

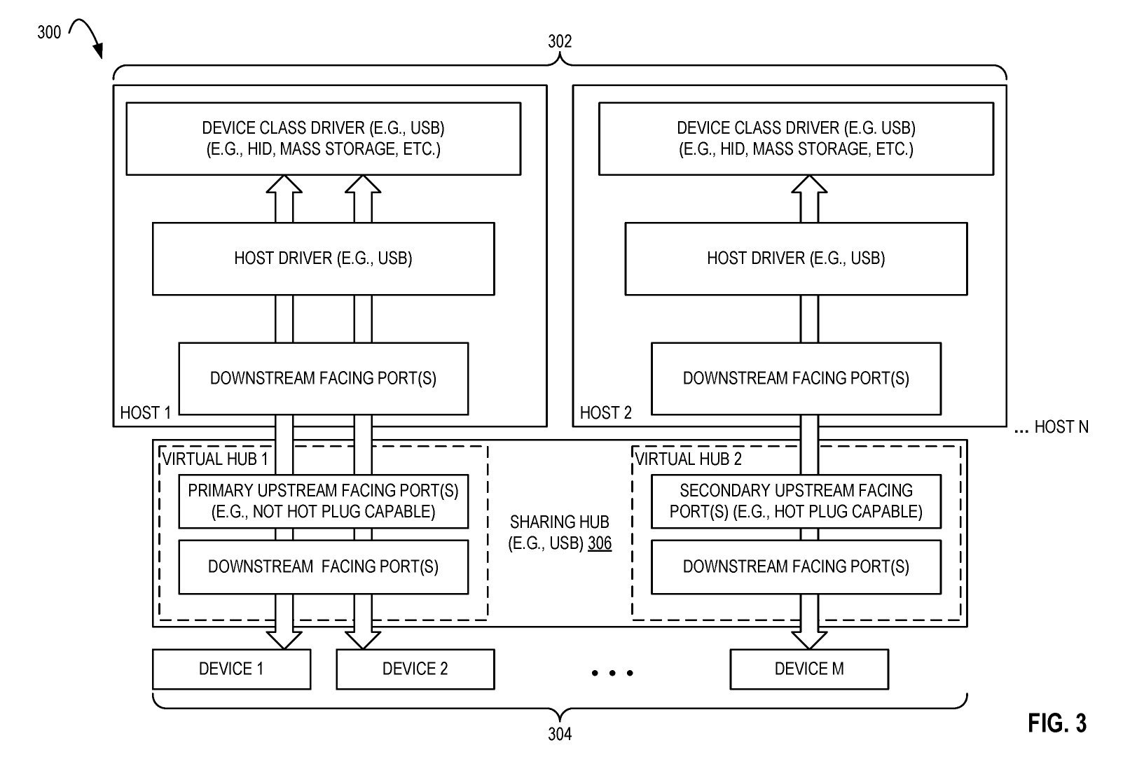

FIG. 3 illustrates a schematic diagram of a system 300 including a plurality of hosts 302 coupled with a wired connection to a plurality of devices 304 via a serial bus hub 306 according to embodiments of the disclosure. In one embodiment, each device connects via a wired connection (e.g., USB cable) to a (e.g., same physical) hub and/or each host connects a wired connection (e.g., USB cable) to the (e.g., same physical) hub. In certain embodiments, a mixture of wired and wireless connections may be utilized, for example, some or all devices may wirelessly (or wired) couple to a hub and some or all hosts may wired (or wirelessly) couple to the hub. In one embodiment, a hub is a component of a computing system, e.g., and not a component of a device (or its upstream facing port).

Plurality of hosts 302 may each include one or more of a device class driver (e.g., for a human interface device (HID), mass storage device, etc.) an operating system (OS) host driver and one or more downstream facing (e.g., USB) ports (e.g., receptacles).

Communication circuitry (e.g., USB cable(s) may provide for a (e.g., data) channel or channels of communication between components, for example, between a host and a (e.g., sharing) hub 306, e.g., between a host and a virtual hub instance. In one embodiment, communication circuitry communicates according to a (e.g., wired) USB standard(s).

In certain embodiments, circuitry (e.g., in physical (e.g., USB) hub 306) spawns one or more virtual hub instances. In the depicted embodiment, hub 306 has spawned a first virtual (e.g., MA-USB) hub instance binding host 1 to device 1 and device 2, and spawned a second virtual (e.g., MA-USB) hub instance binding host 2 to device M, e.g., M may be the number 3, for example, while each device and host is (e.g., concurrently) physically coupled to the same physical hub. In one embodiment, circuitry of a hub is to switch individual physical port(s) into an upstream facing port mode (e.g., to connect to a host) or into a downstream facing port mode (e.g., to connect to a device). In one embodiment, circuitry may bind each downstream facing port (e.g., of a USB host) to a particular upstream facing port (e.g., of a USB device) to allow different (e.g., physically) coupled hosts to each communicate with a (e.g., different) specific device or subset of devices. In one embodiment, each host is able to communicate with (e.g., enumerate) only those devices whose upstream facing ports are electrically coupled to a downstream facing port of that host, for example, the upstream facing ports of devices not bound to a particular host's downstream facing port are not available or affected by that host, e.g., that host's enumeration of the hub's subset of devices bound to the host's downstream facing port.

In one embodiment, a circuit (e.g., as part of a host or hub) is to detect an (e.g., USB) port connect event, and the circuit is then to create a new context (e.g., a device object) for the device that is connected downstream of the port. In one embodiment, this device object is populated with information extracted from the device (e.g., descriptors, etc.) and may be used by the host to store the state of the device. In certain embodiments, a circuit (e.g., as part of a hub) is to detect an event (e.g., the port connect event and/or the new context) and generate a virtual hub instance for the host and device(s) that are to be electrically coupled to provide for a data transfer (e.g., payload data in addition or alternatively to control data). This may occur for each additional host and/or (unused) device that appears (e.g., is electrically coupled) to the hub. For example, the (e.g., virtual host manager) circuit may bind host 1 to device 1 and 2 in a first virtual hub instance and may bind host 2 to device M (e.g., 3) (or a plurality of devices) in a second virtual hub instance. In one embodiment, device 1 and device 2 may be utilized by host 1 and not host 2 and/or device M (e.g., 3) may be utilized by host 2 and not host 1. In one embodiment, host and device(s) on a first virtual hub instance are concurrently (e.g., simultaneously) usable with a second (e.g., any other) virtual hub instance, for example, with each virtual hub instance for all hosts and devices on a single (e.g., physical) hub. In one embodiment, data is actively transmitted in each of multiple virtual hub instances without being interleaved.

Managing which devices go to which host (e.g., upstream port or (MA-USB) virtual instance) may be accomplished by hardware, software, firmware, or a combination thereof. In one embodiment, a (e.g., physical) hub is to accept an additional (e.g., physical) host connection by (e.g., detection circuitry) detecting a host connection event to the hub (e.g., physical) port and (e.g., automatically) setting the connected port to be a downstream facing port, for example, then a dialog is to be shown to the user to allow the user to select which device(s) and/or ports they wish to bind to the new host. This selection of devices may be saved and used (e.g., automatically) for future connections of the same host, for example, if desired by the user. In a MA-USB embodiment, the WSB specification may be utilized to allow hosts to discover the downstream devices and select which (e.g., subset of) devices to bind to the host, for example, as part of the connection process. In another embodiment, a hub (e.g., logic circuitry thereof) is to detect a physical host connection, configure the port of that host to be in downstream facing port mode, and then delay the host's enumeration of upstream facing ports, for example, until the user has selected the ports and/or devices they wish to use (or retrieve this list from a previously saved setting). In certain embodiments, the physical (e.g., USB) hub is reset (and enumerated) only once, at start up. The result of this enumeration may be stored in storage (e.g., of the hub) (e.g., and updated on port connect/disconnect events), and provided to hosts that request a list of available devices, e.g., to avoid re-enumeration of the hub which would adversely affect (e.g., disconnect) hosts that are already connected. In one embodiment, a reset event is faked, e.g., by the virtual (e.g., USB) hub. For example, a (e.g., hub) request may come in to the virtual hub from the host and instead of creating and/or forwarding the (e.g., USB) reset request (e.g., URB) to the physical hub (e.g., the standard procedure of one embodiment of a virtual hub), the virtual (e.g., USB) hub does not create and/or send the reset request to the physical hub, but still sends back a (e.g., MA-USB) response to the host indicating reset success, that is, no reset of the physical hub happened but the host communicating to the virtual hub is sent information that (falsely) indicates that the physical hub did reset successfully and continues with the enumeration. In one embodiment, a reset request (e.g., from a host to a hub), for example, the DevResetReq MA-USB command, to the (e.g., physical) hub is faked during host enumeration of a virtual hub by not performing a physical reset of the (e.g., physical) hub while responding back to the host that the reset was successful.

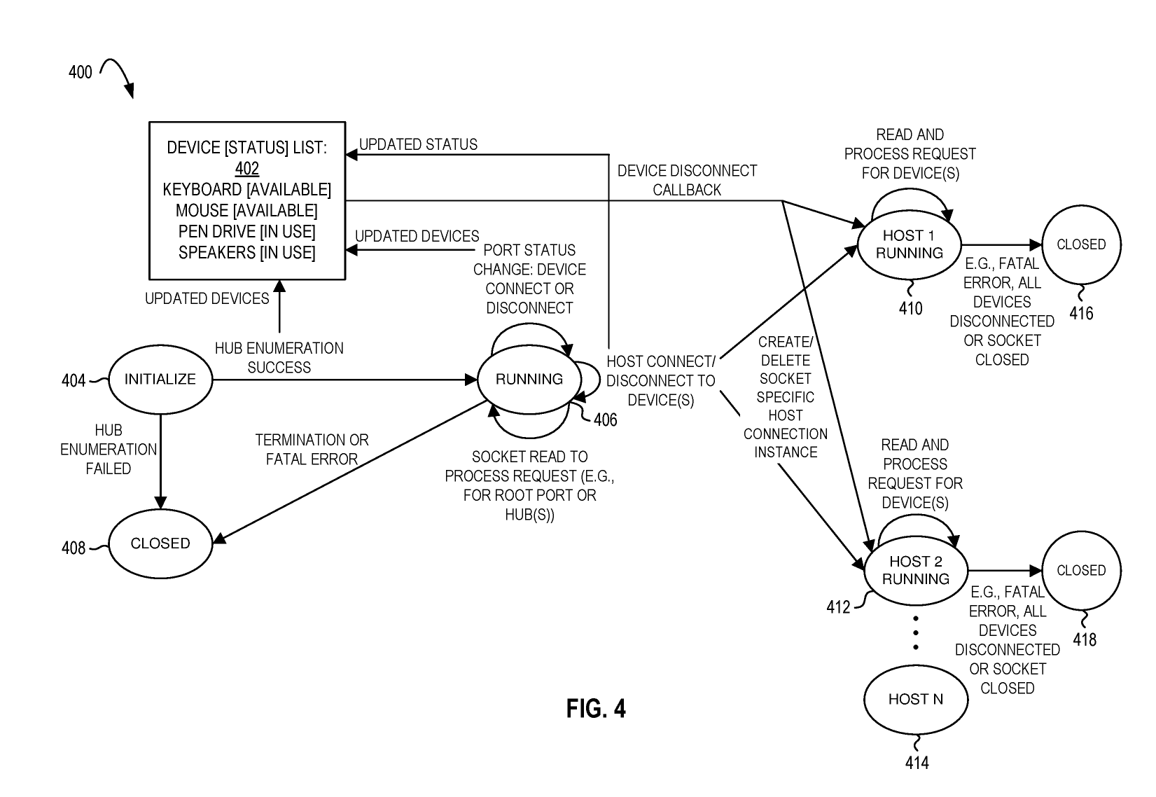

FIG. 4 illustrates a flow diagram 400 of the states of a virtual hub instance according to embodiments of the disclosure. In one embodiment, circuitry (for example, management circuitry in a physical hub, e.g., hub controller circuit) includes a state machine populated according to flow diagram 400. Flow 400 includes a device list 402 with a status for each device. In one embodiment, a hub initializes 404, and if the initialization, for example, the enumeration (e.g., requesting the particulars (e.g., descriptors) (e.g., information indicating the device's capabilities) of or actions by the device or hub, the device or hub returning any requested particulars or performing any requested actions, and/or loading the corresponding driver(s)), is successful, the hub transfers to running 406 state. This may include loading the devices (and their status) that are electrically coupled to the hub to the device list 402. In one embodiment, if the hub does not initialize (e.g., does not enumerate), then the hub transfers to the closed 408 state.

In the running 406 state, a check (e.g., a polling operation) may be performed, e.g., to detect a host connection or disconnection to a device to cause an update of the status of the device (e.g., its communication port) between available and in use in the device list 402, to detect a socket read to process a request, and/or to detect a connection or disconnection of a device to the hub to cause an inclusion or removal of the device in the device list 402.

A virtual hub instance for host 1 may be spawned and run 410, e.g., until it is closed 416. A virtual hub instance for host 2 may be spawned and run 412, e.g., until it is closed 418. One or more additional virtual hub instances may be spawned and run (e.g., 414).

In one embodiment, as a host electrically connects or disconnects to a device or devices (e.g., when the host requests and/or acquires (sole) ownership of a device or returns a device for other host's use), the device list 402 (and each device's status) may be updated. In one embodiment, a device has either a status of in use or available for use, e.g., by a host.

In one embodiment, a communication protocol supports the ability to connect and disconnect a device(s) from a host, and after disconnecting, all disconnected (e.g., upstream facing ports of) devices become available for other (e.g., MA-USB) hosts to use. In one embodiment, use of a (e.g., USB) device is transferred from one host to another of a hub without (e.g., physically) disconnecting the old host from the hub. In one embodiment, a USB compliant way to do this is if the USB device is removable, and if so, the old host is to be notified that the device is to be disconnected, e.g., either through an inter-process communication (IPC) and/or a fake port status changed response (e.g., USB Request Block (URB)) to (falsely) indicate a device removal (e.g., to indicate that a device from a different virtual hub instance is removed even though it was not). For example, once the device is removed from the old host, and the old host is in synch with this removal (e.g. acknowledges the ports status changed response), the device may then be repurposed to the new host that will then (incorrectly) detect a new device is attached (e.g. fake port status connect status changed with status one (1)) and then re-enumerate the USB device before using it. In another embodiment, to share USB devices that are not removable includes adding the capability that a USB device is to declare itself as removable even if it resided on a port that is not removable, e.g., without physically disconnecting the device from the old host before transferring the device to the new host. In this embodiment, the USB devices may support these virtual removable events and then be shared with different hosts, e.g., over MA-USB or a physical upstream port.

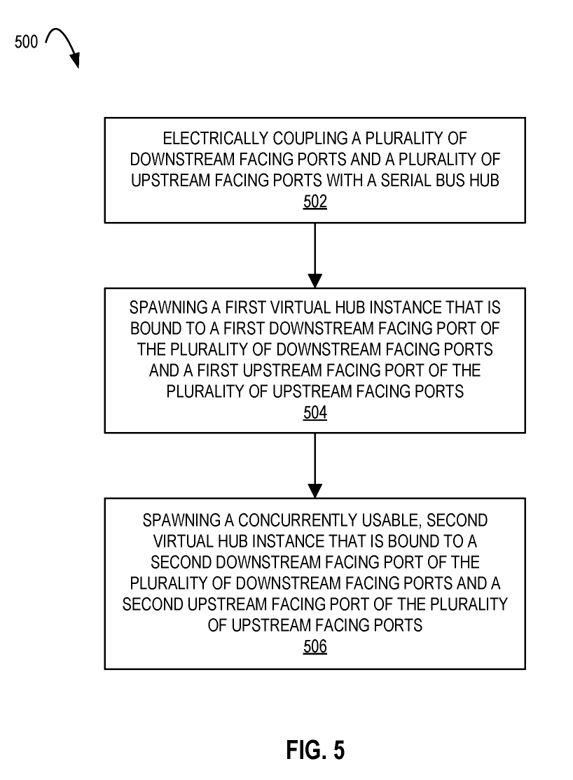

FIG. 5 illustrates a flow diagram 500 of spawning multiple virtual serial bus hub instances on a same physical serial bus hub according to embodiments of the disclosure. Flow 500 includes electrically coupling a plurality of downstream facing ports and a plurality of upstream facing ports with a serial bus hub 502, spawning a first virtual hub instance that is bound to a first downstream facing port of the plurality of downstream facing ports and a first upstream facing port of the plurality of upstream facing ports 504, and spawning a concurrently usable, second virtual hub instance that is bound to a second downstream facing port of the plurality of downstream facing ports and a second upstream facing port of the plurality of upstream facing ports 506. In certain embodiments, one or more of the discussed actions is performed or caused to be performed by a (e.g., USB) host controller.

In one embodiment, an apparatus includes a serial bus hub to electrically couple a plurality of hosts and a plurality of devices; and a circuit to spawn a first virtual hub instance that is bound to a first host of the plurality of hosts and a first device of the plurality of devices, and spawn a concurrently usable, second virtual hub instance that is bound to a second host of the plurality of hosts and a second device of the plurality of devices. A third device of the plurality of devices may be bound by the circuit to the first virtual hub instance with the first device. A host of the plurality of hosts may specify to the circuit a subset of the plurality of devices to be bound to a virtual hub instance. A reset request from the first host may cause a reset of the first virtual hub instance and not a reset of the second virtual hub instance. The reset request from the first host may not cause a reset of the serial bus hub. The first virtual hub instance may send back a response to the host (falsely) indicating reset success of the serial bus hub. The reset request from the first host may cause a reset of the first device and not a reset of the second device. The circuit may present, to a subsequent host electrically coupled to the serial bus hub, a list of the plurality of devices that are not bound to a current virtual hub instance. The first virtual hub instance may be bound to the first host and the first device according to a Universal Serial Bus (USB) specification.

In another embodiment, a method includes electrically coupling a plurality of downstream facing ports and a plurality of upstream facing ports with a serial bus hub; spawning a first virtual hub instance that is bound to a first downstream facing port of the plurality of downstream facing ports and a first upstream facing port of the plurality of upstream facing ports; and spawning a concurrently usable, second virtual hub instance that is bound to a second downstream facing port of the plurality of downstream facing ports and a second upstream facing port of the plurality of upstream facing ports. The method may include binding a third upstream facing port of the plurality of upstream facing ports to the first virtual hub instance having the first upstream facing port. A downstream facing port of the plurality of downstream facing ports may specify a subset of the plurality of upstream facing ports to be bound to a virtual hub instance. A reset request from the first downstream facing port may cause a reset of the first virtual hub instance and not a reset of the second virtual hub instance. The reset request from the first downstream facing port may not cause a reset of the serial bus hub. The first virtual hub instance may send back a response to the first downstream facing port (falsely) indicating reset success of the serial bus hub. The reset request from the first downstream facing port may cause a reset of the first upstream facing port and not a reset of the second upstream facing port. The method may include presenting, to a subsequent downstream facing port electrically coupled to the serial bus hub, a list of the plurality of upstream facing ports that are not bound to a current virtual hub instance. The first virtual hub instance may be bound to the first downstream facing port and the first upstream facing port according to a Universal Serial Bus (USB) specification.

In yet another embodiment, a non-transitory machine readable medium that stores code that when executed by a machine causes the machine to perform a method including electrically coupling a plurality of downstream facing ports and a plurality of upstream facing ports with a serial bus hub; spawning a first virtual hub instance that is bound to a first downstream facing port of the plurality of downstream facing ports and a first upstream facing port of the plurality of upstream facing ports; and spawning a concurrently usable, second virtual hub instance that is bound to a second downstream facing port of the plurality of downstream facing ports and a second upstream facing port of the plurality of upstream facing ports. The method may include binding a third upstream facing port of the plurality of upstream facing ports to the first virtual hub instance having the first upstream facing port. A downstream facing port of the plurality of downstream facing ports may specify a subset of the plurality of upstream facing ports to be bound to a virtual hub instance. A reset request from the first downstream facing port may cause a reset of the first virtual hub instance and not a reset of the second virtual hub instance. The reset request from the first downstream facing port may not cause a reset of the serial bus hub. The first virtual hub instance may send back a response to the first downstream facing port (falsely) indicating reset success of the serial bus hub. The reset request from the first downstream facing port may cause a reset of the first upstream facing port and not a reset of the second upstream facing port. The method may include presenting, to a subsequent downstream facing port electrically coupled to the serial bus hub, a list of the plurality of upstream facing ports that are not bound to a current virtual hub instance. The first virtual hub instance may be bound to the first downstream facing port and the first upstream facing port according to a Universal Serial Bus (USB) specification.

In another embodiment, an apparatus includes a serial bus hub to electrically couple a plurality of hosts and a plurality of devices; and means to spawn a first virtual hub instance that is bound to a first host of the plurality of hosts and a first device of the plurality of devices, and spawn a concurrently usable, second virtual hub instance that is bound to a second host of the plurality of hosts and a second device of the plurality of devices.

In yet another embodiment, an apparatus comprises a data storage device that stores code that when executed by a hardware processor causes the hardware processor to perform any method disclosed herein. An apparatus may be as described in the detailed description. A method may be as described in the detailed description.

In another embodiment, a non-transitory machine readable medium that stores code that when executed by a machine causes the machine to perform a method comprising any method disclosed herein.

In yet another embodiment, it is possible to virtualize individual USB devices instead of a hub and achieve a similar user experience (e.g., sharing different devices with different hosts), for example, in this scenario it would be a virtual device instead of a virtual hub, e.g., with a first virtual device instance and a second virtual device instance replacing the first virtual hub instance and second virtual hub instance, respectively.

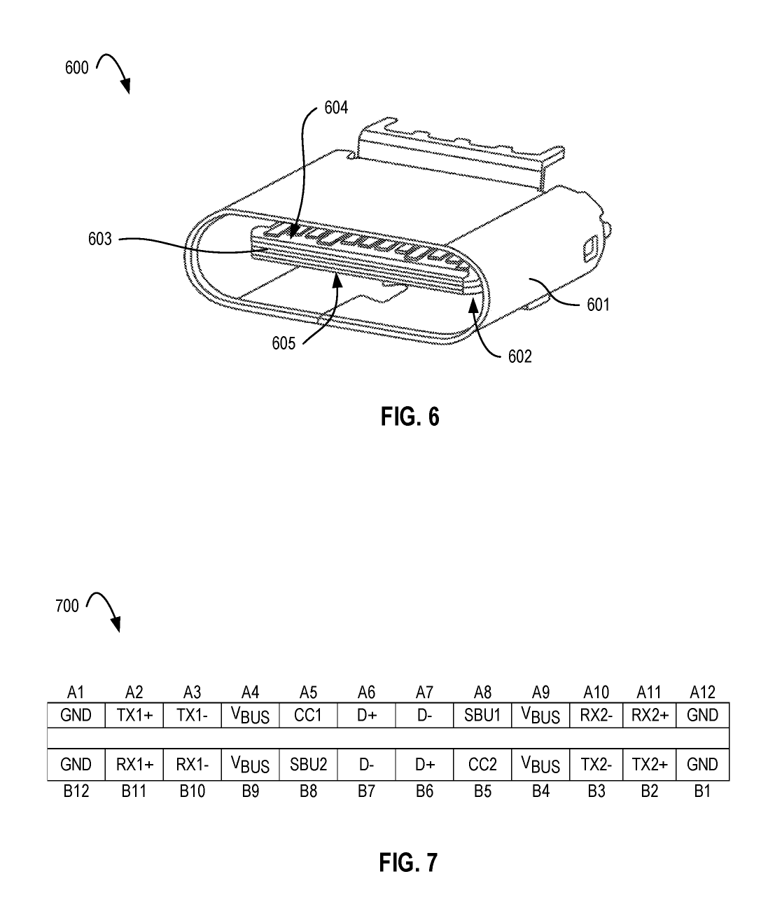

FIGS. 6-9 below discuss embodiments of receptacles and plugs to connect one device to another device. Table 1 that follows depicts embodiments of channels (e.g., conductors) to allow signals to flow between multiple devices (e.g., between a USB host and USB device).

TABLE 1
Example Communication Channels

| | Signal | | Mating | | Signal | | Mating |
|---|---|---|---|---|---|---|---|
| Pin | Name | Description | Sequence | Pin | Name | Description | Sequence |
| A1 | GND | Ground | First | B12 | GND | Ground | First |
| | | return | | | | return | |
| A2 | SSTXp1 | Positive half | Second | B11 | SSRXp1 | Positive half | Second |
| | | of first (e.g., | | | | of first (e.g., | |
| | | SuperSpeed) | | | | SuperSpeed) | |
| | | transmitter | | | | receiver (RX) | |
| | | (TX) | | | | differential | |
| | | differential | | | | pair of the | |
| | | pair of a first | | | | first type | |
| | | type | | | | | |
| A3 | SSTXn1 | Negative half | Second | B10 | SSRXn1 | Negative half | Second |
| | | of first (e.g., | | | | of first (e.g., | |
| | | SuperSpeed) | | | | SuperSpeed) | |
| | | TX | | | | RX | |
| | | differential | | | | differential | |
| | | pair of the | | | | pair of the | |
| | | first type | | | | first type | |
| A4 | VBUS | Bus Power | First | B9 | VBUS | Bus Power | First |
| A5 | CC1 | Configuration | Second | B8 | SBU2 | Sideband Use | Second |
| | | Channel | | | | (SBU) | |
| A6 | Dp1 | Positive half | Second | B7 | Dn2 | Negative half | Second |
| | | of a second | | | | of the second | |
| | | type (e.g., | | | | type (e.g., | |
| | | USB 2.0) of | | | | USB 2.0) of | |
| | | differential | | | | differential | |
| | | pair - | | | | pair - | |
| | | Position 1 | | | | Position 2 | |
| A7 | Dn1 | Negative half | Second | B6 | Dp2 | Positive half | Second |
| | | of the second | | | | of the second | |
| | | type (e.g., | | | | type (e.g., | |
| | | USB 2.0) of | | | | USB 2.0) of | |
| | | differential | | | | differential | |
| | | pair - | | | | pair - | |
| | | Position 1 | | | | Position 2 | |
| A8 | SBU1 | Sideband Use | Second | B5 | CC2 | Configuration | Second |
| | | (SBU) | | | | Channel | |
| A9 | VBUS | Bus Power | First | B4 | VBUS | Bus Power | First |
| A10 | SSRXn2 | Negative half | Second | B3 | SSTXn2 | Negative half | Second |
| | | of second | | | | of second | |
| | | (e.g., | | | | (e.g., | |
| | | SuperSpeed) | | | | SuperSpeed) | |
| | | RX | | | | TX | |
| | | differential | | | | differential | |
| | | pair of the | | | | pair of the | |
| | | first type | | | | first type | |
| A11 | SSRXp2 | Positive half | Second | B2 | SSTXp2 | Positive half | Second |
| | | of second | | | | of second | |
| | | (e.g., | | | | (e.g., | |
| | | SuperSpeed) | | | | SuperSpeed) | |
| | | RX | | | | TX | |
| | | differential | | | | differential | |
| | | pair of the | | | | pair of the | |
| | | first type | | | | first type | |
| A12 | GND | Ground | First | B1 | GND | Ground | First |
| | | return | | | | return | |

FIG. 6 illustrates a perspective view of a serial bus receptacle 600 according to embodiments of the disclosure. In certain embodiments, serial bus receptacle 600 may be part of (e.g., within) a device (e.g., mounted to a circuit board of a device).

FIG. 7 illustrates a schematic diagram 700 of the pins of a serial bus receptacle (e.g., serial bus receptacle 600) according to embodiments of the disclosure.

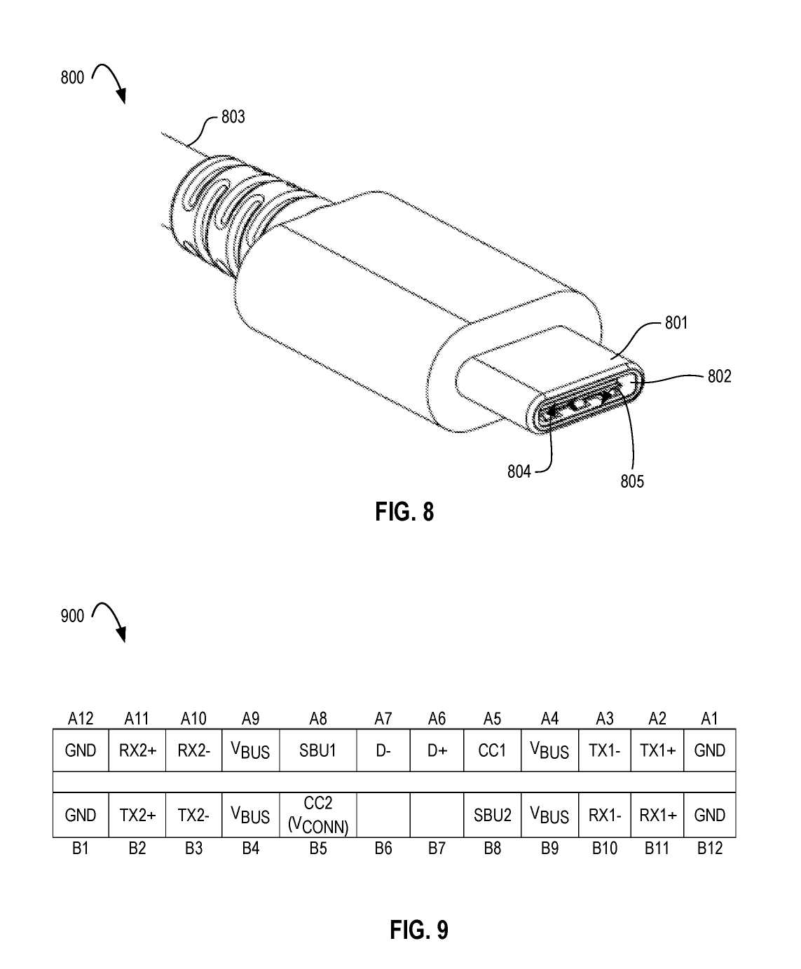

FIG. 8 illustrates a perspective view of a serial bus plug 800 according to embodiments of the disclosure. In certain embodiments, serial bus plug may connect (e.g., physically and electrically) to a serial bus receptacle (e.g., serial bus receptacle 600).

FIG. 9 illustrates a schematic diagram 900 of the pins of a serial bus plug (e.g., serial bus plug 800) according to embodiments of the disclosure.

In certain embodiments, a serial bus plug is flip-able between a right-side up position and an upside-down position (relative to the receptacle it is to be inserted into). In certain embodiments, (e.g., serial bus) plug 800 of FIG. 8 slides within (e.g., serial bus) receptacle 600 of FIG. 6, e.g., the housing 801 slides within the shell 601 (e.g., enclosure). Tongue 602 may be (e.g., fixedly) disposed within the bore of the shell 601 of the serial bus receptacle. Depicted tongue 602 includes a first (e.g., substantially planar) side 604 and an opposing second (e.g., substantially planar) side 605. In one embodiment, first side 604 is (e.g., substantially) parallel to the second side 605. One or both of first side 604 and second side 605 may include electrical contacts (e.g., pins, pads, springs, etc.) thereon, e.g., facing in opposing directions. A longitudinal axis of each electrical contact may extend from the rear of shell 601 towards the opening at the front of shell 601, for example, along the first side 604 and/or the second side 605. A leading edge 603 of the tongue 602 may be (e.g., substantially) perpendicular to the first side 604 and the second side 605. The body of the tongue 602, e.g., excluding any electrical contacts thereon, may be a non-conductive material, for example, glass-filled nylon. The leading edge 603 of the tongue 602 may not include any electrical contacts to mate with the electrical (for example, signal and/or data, e.g., but not ground) contacts of a plug. The back wall of the receptacle may not include any electrical contacts to mate with the electrical (for example, signal and/or data, e.g., but not ground) contacts of a plug. First side 604 may include (e.g., only) a first row of electrical contacts thereon, for example, the electrical contacts (e.g., pins) in FIG. 7, e.g., pins A1-A12. Second side 605 may include (e.g., only) a second row of electrical contacts thereon, for example, the electrical contacts (e.g., pins) in FIG. 7, e.g., pins B12-B1. Electrical contacts may physically connect (e.g., fixedly connect) to the circuitry of a device, e.g., a multiple role togging circuit or other circuitry discussed herein.

Turning again to FIG. 8, in certain embodiments, the serial bus plug 800 includes a housing 801 with a bore therein, e.g., having an opening at the front of the housing 801 and a back wall opposite of the opening. Housing 801 may include electrical contacts in the bore thereof. A first side 804 of the interior of the housing may be (e.g., substantially) parallel to a second side 805 of the interior of the housing of the serial bus plug 800. One or both of first side 804 and second side 805 may include electrical contacts (e.g., pins, pads, springs, etc.) thereon, e.g., facing each other. Contacts on the first side 804 and/or the second side 805 may couple (e.g., physically and electrically connect) to the first side 604 and/or the second side 605 of receptacle 600. In one embodiment, a first side 804 of plug 800 couples with either of the first side 604 and the second side 605 of the receptacle 600 and the second side 805 of the plug 800 couples with the other of the first side 604 and the second side 605 of the receptacle 600 (e.g., flip-able). A longitudinal axis of each electrical contact may extend from the rear of housing 801 towards the opening 802 at the front of housing 801, for example, along the first side 804 and/or the second side 805. Housing 801 may be slideably received within an (e.g., continuous) annulus formed between the exterior surface of the tongue 602 and an interior surface of the shell 601 of the receptacle 600. The leading edge of the housing 801 not include any electrical contacts to mate with the electrical (for example, signal and/or data, e.g., but not ground) contacts of a receptacle. The back wall of the housing 801 may not include any electrical contacts to mate with the electrical (for example, signal and/or data, e.g., but not ground) contacts of a receptacle. First side 804 may include (e.g., only) a first row of electrical contacts thereon, for example, the electrical contacts (e.g., pins) in FIG. 9, e.g., pins A12-A1. Second side 805 may include (e.g., only) a second row of electrical contacts thereon, for example, the electrical contacts (e.g., pins) in FIG. 9, e.g., pins B1-B12. Electrical contacts may physically connect (e.g., fixedly connect) to a cable 803 or other electrical conductors (for example, wires to a memory device, e.g., a USB memory stick). Cable 803 may connect to another plug, e.g., to connect to a receptacle that physically connects to the circuitry of a device, e.g., a multiple role togging circuit or other circuitry discussed herein.

Circuitry (e.g., a hub, host, and/or device) may include a transmitter and/or a receiver to send and receive data, respectively, e.g., as part of a transceiver (e.g., a physical layer (PHY) circuit).

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality of Service (QoS), Hot-Plug/Hot-Swap support, Data Integrity, and Error Handling are among some of the advanced features supported by PCI Express.

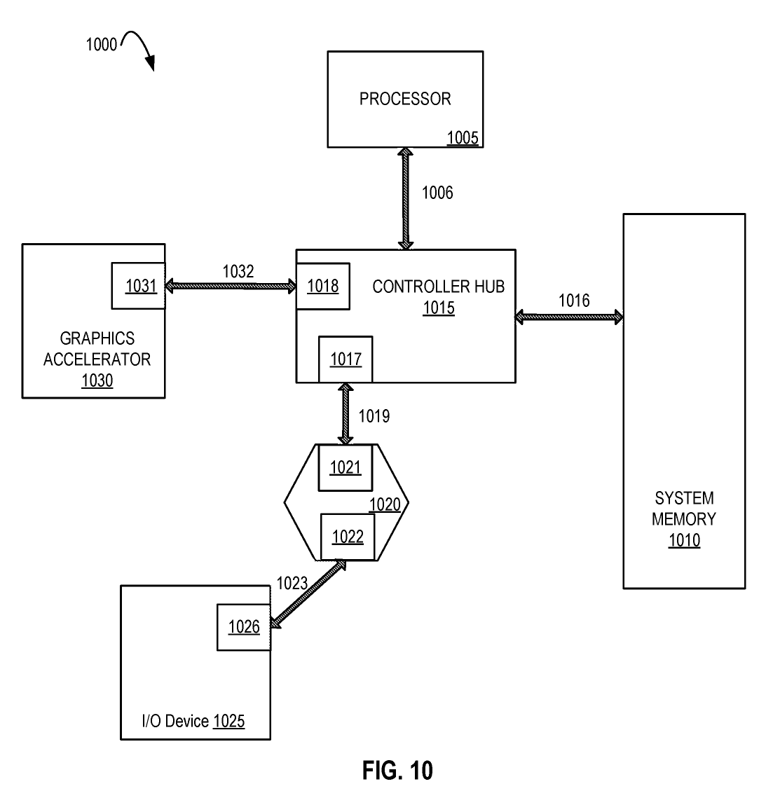

Referring to FIG. 10, an embodiment of a fabric composed of point-to-point Links that interconnect a set of components is illustrated. System 1000 includes processor 1005 and system memory 1010 coupled to controller hub 1015. Processor 1005 includes any processing element, such as a microprocessor, a host processor, an embedded processor, a co-processor, or other processor. Processor 1005 is coupled to controller hub 1015 through front-side bus (FSB) 1006. In one embodiment, FSB 1006 is a serial point-to-point interconnect as described below. In another embodiment, link 1006 includes a serial, differential interconnect architecture that is compliant with different interconnect standard.

System memory 1010 includes any memory device, such as random access memory (RAM), non-volatile (NV) memory, or other memory accessible by devices in system 1000. System memory 1010 is coupled to controller hub 1015 through memory interface 1016. Examples of a memory interface include a double-data rate (DDR) memory interface, a dual-channel DDR memory interface, and a dynamic RAM (DRAM) memory interface.

In one embodiment, controller hub 1015 is a root hub, root complex, or root controller in a Peripheral Component Interconnect Express (PCIe or PCIE) interconnection hierarchy. Examples of controller hub 1015 include a chipset, a memory controller hub (MCH), a northbridge, an interconnect controller hub (ICH) a southbridge, and a root controller/hub. Often the term chipset refers to two physically separate controller hubs, e.g., a memory controller hub (MCH) coupled to an interconnect controller hub (ICH). Note that current systems often include the MCH integrated with processor 1005, while controller 1015 is to communicate with I/O devices, in a similar manner as described below. In some embodiments, peer-to-peer routing is optionally supported through root complex 1015.

Here, controller hub 1015 is coupled to switch/bridge 1020 through serial link 1019. Input/output modules 1017 and 1021, which may also be referred to as interfaces/ports 1017 and 1021, include/implement a layered protocol stack to provide communication between controller hub 1015 and switch 1020. In one embodiment, multiple devices are capable of being coupled to switch 1020.

Switch/bridge 1020 routes packets/messages from device 1025 upstream, e.g., up a hierarchy towards a root complex, to controller hub 1015 and downstream, e.g., down a hierarchy away from a root controller, from processor 1005 or system memory 1010 to device 1025. Switch 1020, in one embodiment, is referred to as a logical assembly of multiple virtual PCI-to-PCI bridge devices. Device 1025 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 1025 may include a PCIe to PCI/PCI-X bridge to support legacy or other version PCI devices. Endpoint devices in PCIe are often classified as legacy, PCIe, or root complex integrated endpoints.

Graphics accelerator 1030 is also coupled to controller hub 1015 through serial link 1032. In one embodiment, graphics accelerator 1030 is coupled to an MCH, which is coupled to an ICH. Switch 1020, and accordingly to I/O device 1025 through serial link 1023, is then coupled to the ICH. I/O modules 1031 and 1018 are also to implement a layered protocol stack to communicate between graphics accelerator 1030 and controller hub 1015. Similar to the MCH discussion above, a graphics controller or the graphics accelerator 1030 itself may be integrated in processor 1005.

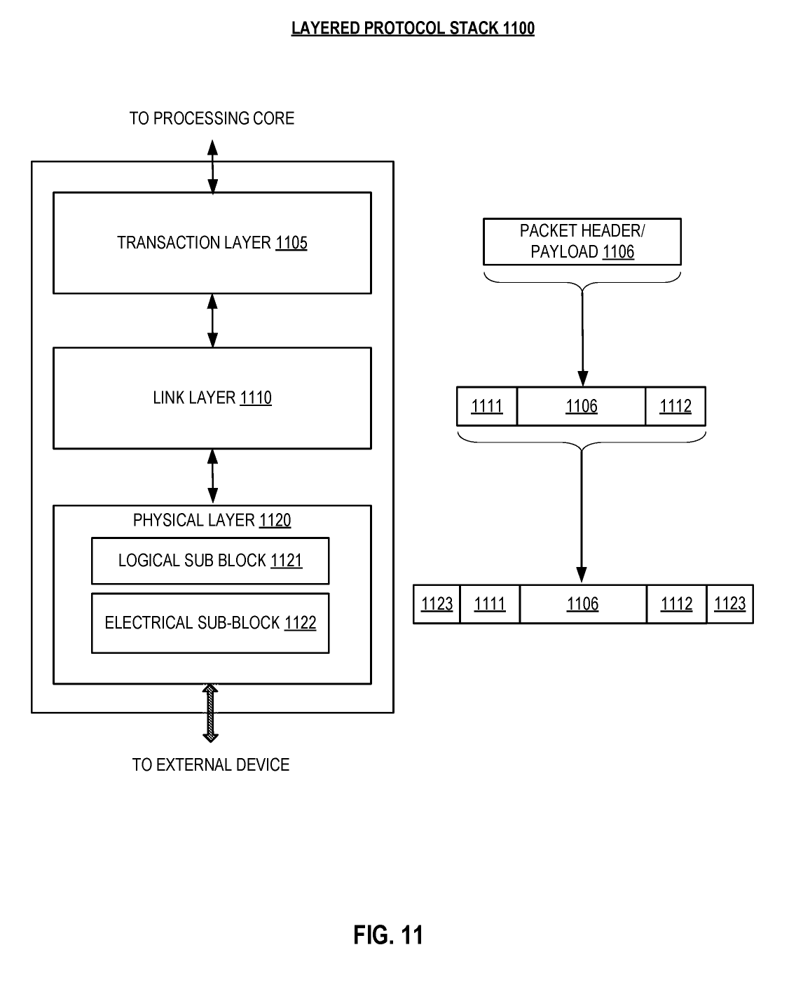

Turning to FIG. 11 an embodiment of a layered protocol stack is illustrated. Layered protocol stack 1100 includes any form of a layered communication stack, such as a Quick Path Interconnect (QPI) stack, a PCIe stack, a next generation high performance computing interconnect stack, or other layered stack. Although the discussion immediately below in reference to FIGS. 10-13 are in relation to a PCIe stack, the same concepts may be applied to other interconnect stacks. In one embodiment, protocol stack 1100 is a PCIe protocol stack including transaction layer 1105, link layer 1110, and physical layer 1120. An interface, such as interfaces 1017, 1018, 1021, 1022, 1026, and 1031 in FIG. 10, may be represented as communication protocol stack 1100. Representation as a communication protocol stack may also be referred to as a module or interface implementing/including a protocol stack.

PCI Express uses packets to communicate information between components. Packets are formed in the Transaction Layer 1105 and Data Link Layer 1110 to carry the information from the transmitting component to the receiving component. As the transmitted packets flow through the other layers, they are extended with additional information necessary to handle packets at those layers. At the receiving side the reverse process occurs and packets get transformed from their Physical Layer 1120 representation to the Data Link Layer 1110 representation and finally (for Transaction Layer Packets) to the form that can be processed by the Transaction Layer 1105 of the receiving device.

### Transaction Layer

In one embodiment, transaction layer 1105 is to provide an interface between a device's processing core and the interconnect architecture, such as data link layer 1110 and physical layer 1120. In this regard, a primary responsibility of the transaction layer 1105 is the assembly and disassembly of packets (e.g., transaction layer packets, or TLPs). The translation layer 1105 typically manages credit-base flow control for TLPs. PCIe implements split transactions, e.g., transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 1105. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 1105 assembles packet header/payload 1106. Format for current packet headers/payloads may be found in the PCIe specification at the PCIe specification website.

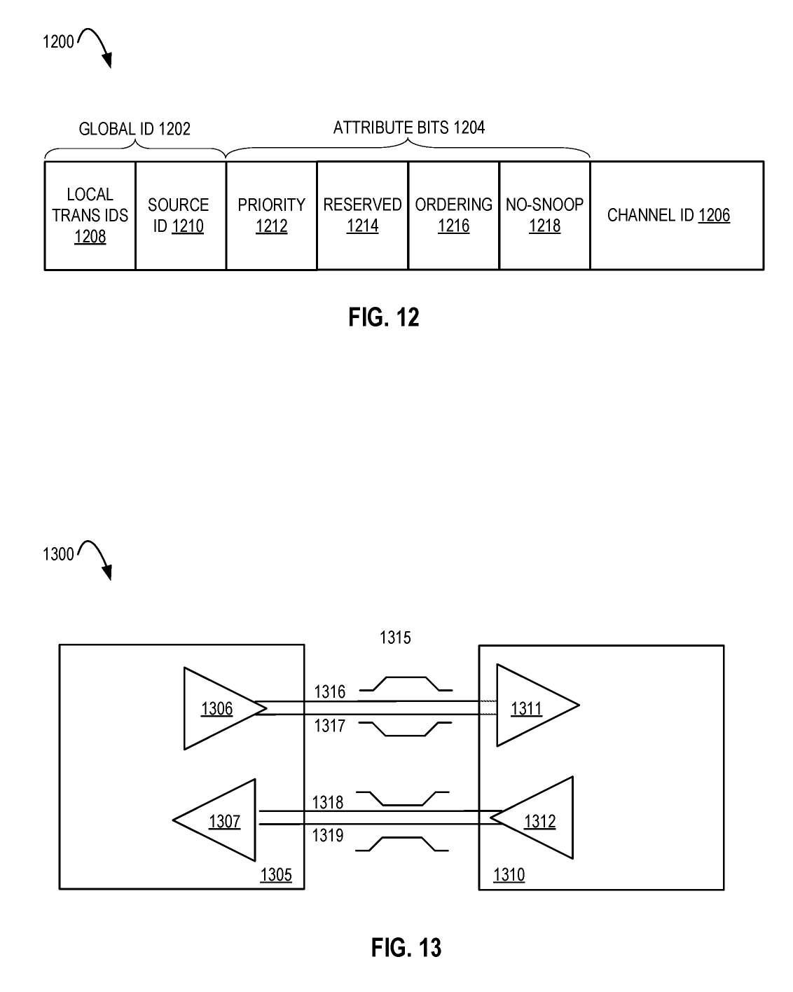

Referring to FIG. 12, an embodiment of a PCIe transaction descriptor is illustrated. In one embodiment, transaction descriptor 1200 is a mechanism for carrying transaction information. In this regard, transaction descriptor 1200 supports identification of transactions in a system. Other potential uses include tracking modifications of default transaction ordering and association of transaction with channels.

Transaction descriptor 1200 includes global identifier field 1202, attributes field 1204 and channel identifier field 1206. In the illustrated example, global identifier field 1202 is depicted comprising local transaction identifier field 1208 and source identifier field 1210. In one embodiment, global transaction identifier 1202 is unique for all outstanding requests.

According to one implementation, local transaction identifier field 1208 is a field generated by a requesting agent, and it is unique for all outstanding requests that require a completion for that requesting agent. Furthermore, in this example, source identifier 1210 uniquely identifies the requestor agent within a PCIe hierarchy. Accordingly, together with source ID 1210, local transaction identifier 1208 field provides global identification of a transaction within a hierarchy domain.

Attributes field 1204 specifies characteristics and relationships of the transaction. In this regard, attributes field 1204 is potentially used to provide additional information that allows modification of the default handling of transactions. In one embodiment, attributes field 1204 includes priority field 1212, reserved field 1214, ordering field 1216, and no-snoop field 1218. Here, priority sub-field 1212 may be modified by an initiator to assign a priority to the transaction. Reserved attribute field 1214 is left reserved for future, or vendor-defined usage. Possible usage models using priority or security attributes may be implemented using the reserved attribute field.

In this example, ordering attribute field 1216 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 1618 is utilized to determine if transactions are snooped. As shown, channel ID Field 1206 identifies a channel that a transaction is associated with.

### Link Layer

Link layer 1110, also referred to as data link layer 1110, acts as an intermediate stage between transaction layer 1105 and the physical layer 1120. In one embodiment, a responsibility of the data link layer 1110 is providing a reliable mechanism for exchanging Transaction Layer Packets (TLPs) between two components a link. One side of the Data Link Layer 1110 accepts TLPs assembled by the Transaction Layer 1105, applies packet sequence identifier 1111, e.g., an identification number or packet number, calculates and applies an error detection code, e.g., CRC 1112, and submits the modified TLPs to the Physical Layer 1120 for transmission across a physical to an external device.

### Physical Layer

In one embodiment, physical layer 1120 includes logical sub block 1121 and electrical sub-block 1122 to physically transmit a packet to an external device. Here, logical sub-block 1121 is responsible for the “digital” functions of Physical Layer 1121. In this regard, the logical sub-block includes a transmit section to prepare outgoing information for transmission by physical sub-block 1122, and a receiver section to identify and prepare received information before passing it to the Link Layer 1110.

Physical block 1122 includes a transmitter and a receiver. The transmitter is supplied by logical sub-block 1121 with symbols, which the transmitter serializes and transmits onto to an external device. The receiver is supplied with serialized symbols from an external device and transforms the received signals into a bit-stream. The bit-stream is de-serialized and supplied to logical sub-block 1121. In one embodiment, an 8 b/10 b transmission code is employed, where ten-bit symbols are transmitted/received. Here, special symbols are used to frame a packet with frames 1123. In addition, in one example, the receiver also provides a symbol clock recovered from the incoming serial stream.

As stated above, although transaction layer 1105, link layer 1110, and physical layer 1120 are discussed in reference to a specific embodiment of a PCIe protocol stack, a layered protocol stack is not so limited. In fact, any layered protocol may be included/implemented. As an example, a port/interface that is represented as a layered protocol includes: (1) a first layer to assemble packets, e.g., a transaction layer; a second layer to sequence packets, e.g., a link layer; and a third layer to transmit the packets, e.g., a physical layer. As a specific example, a common standard interface (CSI) layered protocol is utilized.

Referring next to FIG. 13, an embodiment of a PCIe serial point to point fabric 1300 is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 1306/1311 and a receive pair 1312/1307. Accordingly, device 1305 includes transmission logic 1306 to transmit data to device 1310 and receiving logic 1307 to receive data from device 1310. In other words, two transmitting paths, e.g., paths 1316 and 1317, and two receiving paths, e.g., paths 1318 and 1319, are included in a PCIe link.

A transmission path refers to any path for transmitting data, such as a transmission line, a copper line, an optical line, a wireless communication channel, an infrared communication link, or other communication path. A connection between two devices, such as device 1305 and device 1310, is referred to as a link, such as link 1315. A link may support one lane—each lane representing a set of differential signal pairs (one pair for transmission, one pair for reception). To scale bandwidth, a link may aggregate multiple lanes denoted by ×N, where N is any supported Link width, such as 1, 2, 4, 8, 12, 16, 32, 64, or wider.

A differential pair refers to two transmission paths, such as lines 1316 and 1317, to transmit differential signals. As an example, when line 1316 toggles from a low voltage level to a high voltage level, e.g., a rising edge, line 1317 drives from a high logic level to a low logic level, e.g., a falling edge. Differential signals potentially demonstrate better electrical characteristics, such as better signal integrity, e.g., cross-coupling, voltage overshoot/undershoot, ringing, etc. This allows for better timing window, which enables faster transmission frequencies.

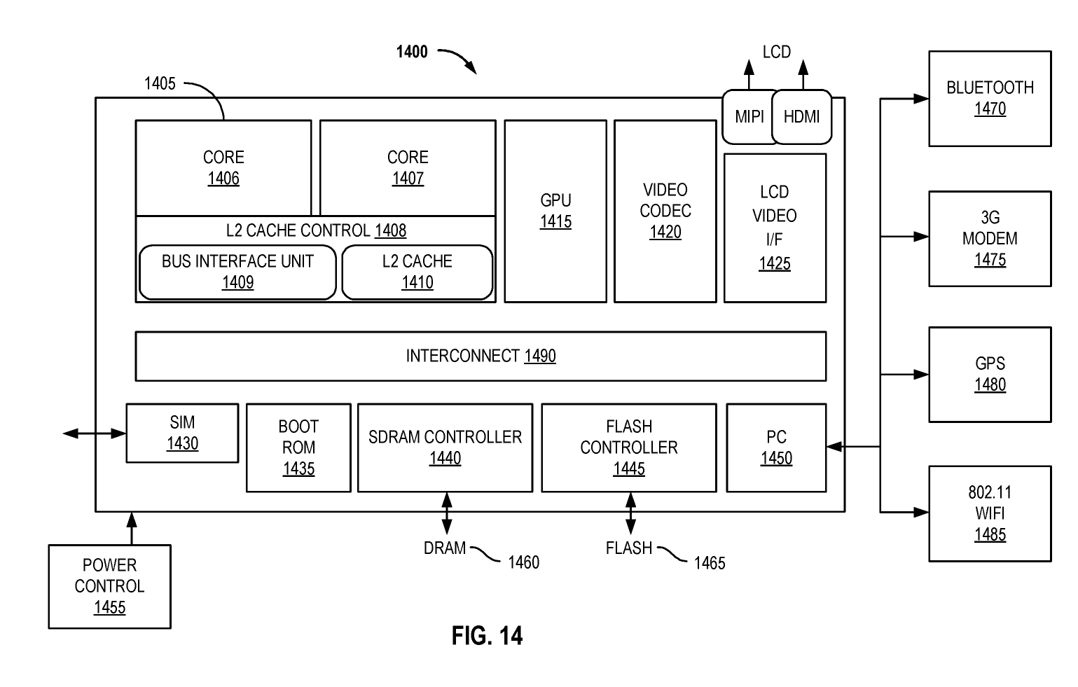

Turning next to FIG. 14, an embodiment of a system on-chip (SOC) design in accordance with the embodiments is depicted. As a specific illustrative example, SOC 1400 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1400 includes 2 cores—1406 and 1407. Similar to the discussion above, cores 1406 and 1407 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1406 and 1407 are coupled to cache control 1408 that is associated with bus interface unit 1409 and L2cache 1410 to communicate with other parts of system 1400. Interconnect 1490 includes an on-chip interconnect, such as an IOSF, AMBA, or other interconnect discussed above, which potentially implements one or more aspects of the described embodiments.

Interconnect 1490 provides communication channels to the other components, such as a Subscriber Identity Module (SIM) 1430 to interface with a SIM card, a boot ROM 1435 to hold boot code for execution by cores 1406 and 1407 to initialize and boot SOC 1400, a SDRAM controller 1440 to interface with external memory (e.g. DRAM 1460), a flash controller 1445 to interface with non-volatile memory (e.g. Flash 1465), a peripheral control 1450 (e.g. Serial Peripheral Interface) to interface with peripherals, video codecs 1420 and Video interface 1425 to display and receive input (e.g. touch enabled input), GPU 1415 to perform graphics related computations, etc. Any of these interfaces may incorporate aspects of the embodiments described herein.

In addition, the system illustrates peripherals for communication, such as a Bluetooth module 1470, 3G modem 1475, GPS 1480, and WiFi 1485. Note as stated above, a UE includes a radio for communication. As a result, these peripheral communication modules are not all required. However, in a UE some form a radio for external communication is to be included.

Note that the apparatus, methods, and systems described above may be implemented in any electronic device or system as aforementioned. As specific illustrations, the figures below provide exemplary systems for utilizing the embodiments as described herein. As the systems below are described in more detail, a number of different interconnects are disclosed, described, and revisited from the discussion above. And as is readily apparent, the advances described above may be applied to any of those interconnects, fabrics, or architectures.

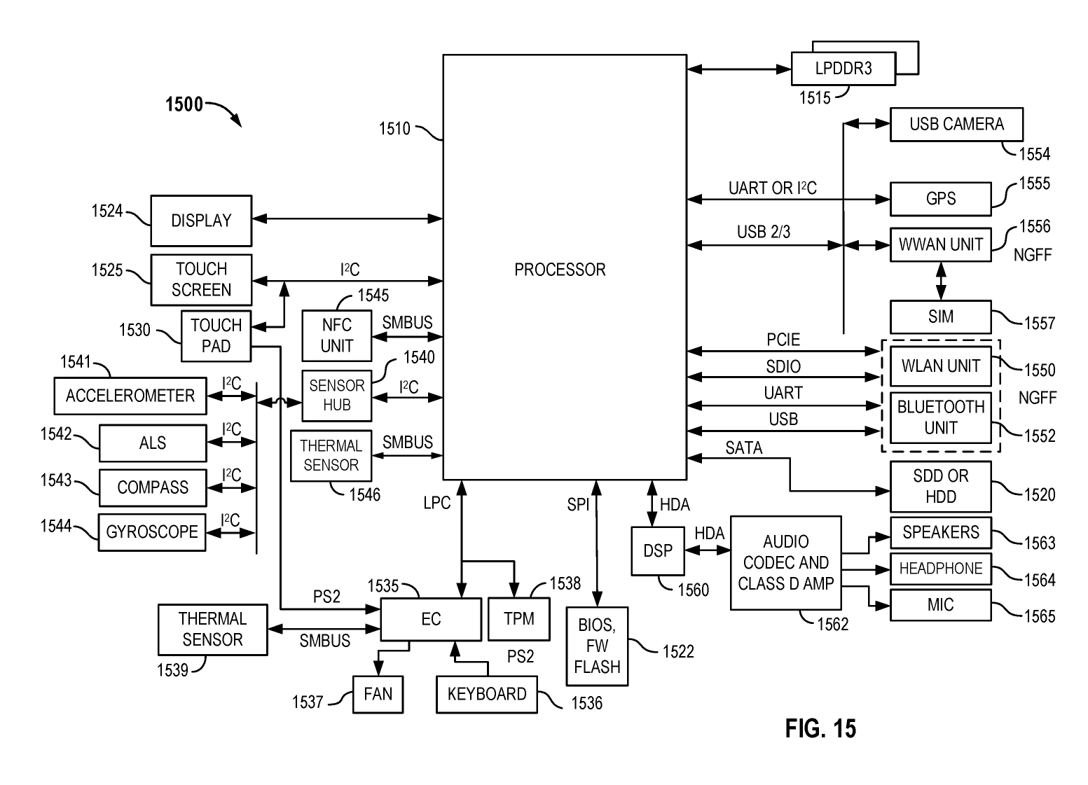

Referring now to FIG. 15, a block diagram of components present in a computer system in accordance with embodiments of the disclosure is illustrated. As shown in FIG. 15, system 1500 includes any combination of components. These components may be implemented as ICs, portions thereof, discrete electronic devices, or other modules, logic, hardware, software, firmware, or a combination thereof adapted in a computer system, or as components otherwise incorporated within a chassis of the computer system. Note also that the block diagram of FIG. 15 is intended to show a high level view of many components of the computer system. However, it is to be understood that some of the components shown may be omitted, additional components may be present, and different arrangement of the components shown may occur in other implementations. As a result, the embodiments described above may be implemented in any portion of one or more of the interconnects illustrated or described below.

As seen in FIG. 15, a processor 1510, in one embodiment, includes a microprocessor, multi-core processor, multithreaded processor, an ultra low voltage processor, an embedded processor, or other known processing element. In the illustrated implementation, processor 1510 acts as a main processing unit and central hub for communication with many of the various components of the system 1500. As one example, processor 1510 is implemented as a system on a chip (SoC). As a specific illustrative example, processor 1510 includes an Intel® Architecture Core™-based processor such as an i3, i5, i7 or another such processor available from Intel Corporation, Santa Clara, Calif. However, understand that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A5/A6 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the microarchitectural implementation may vary, but the architectural function of the processor is usually consistent. Certain details regarding the architecture and operation of processor 1510 in one implementation will be discussed further below to provide an illustrative example.

Processor 1510, in one embodiment, communicates with a system memory 1515. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (Q17P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage 1520 may also couple to processor 1510. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also shown in FIG. 15, a flash device 1522 may be coupled to processor 1510, e.g., via a serial peripheral interface (SPI). This flash device may provide for non-volatile storage of system software, including a basic input/output software (BIOS) as well as other firmware of the system.

In various embodiments, mass storage of the system is implemented by a SSD alone or as a disk, optical or other drive with an SSD cache. In some embodiments, the mass storage is implemented as a SSD or as a HDD along with a restore (RST) cache module. In various implementations, the HDD provides for storage of between 320 GB-4 terabytes (TB) and upward while the RST cache is implemented with a SSD having a capacity of 24 GB-256 GB. Note that such SSD cache may be configured as a single level cache (SLC) or multi-level cache (MLC) option to provide an appropriate level of responsiveness. In a SSD-only option, the module may be accommodated in various locations such as in a mSATA or NGFF slot. As an example, an SSD has a capacity ranging from 120 GB-1 TB.

Various input/output (IO) devices may be present within system 1500. Specifically shown in the embodiment of FIG. 15 is a display 1524 which may be a high definition LCD or LED panel configured within a lid portion of the chassis. This display panel may also provide for a touch screen 1525, e.g., adapted externally over the display panel such that via a user's interaction with this touch screen, user inputs can be provided to the system to enable desired operations, e.g., with regard to the display of information, accessing of information and so forth. In one embodiment, display 1524 may be coupled to processor 1510 via a display interconnect that can be implemented as a high performance graphics interconnect. Touch screen 1525 may be coupled to processor 1510 via another interconnect, which in an embodiment can be an I²C interconnect. As further shown in FIG. 15, in addition to touch screen 1525, user input by way of touch can also occur via a touch pad 1530 which may be configured within the chassis and may also be coupled to the same I²C interconnect as touch screen 1525.

The display panel may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self-refresh.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 cm per frame (30 Hz) with 200 ms (lag on finger to pointer). The display, in some implementations, supports edge-to-edge glass with a minimal screen bezel that is also flush with the panel surface, and limited IO interference when using multi-touch.

For perceptual computing and other purposes, various sensors may be present within the system and may be coupled to processor 1510 in different manners. Certain inertial and environmental sensors may couple to processor 1510 through a sensor hub 1540, e.g., via an I²C interconnect. In the embodiment shown in FIG. 15, these sensors may include an accelerometer 1541, an ambient light sensor (ALS) 1542, a compass 1543 and a gyroscope 1544. Other environmental sensors may include one or more thermal sensors 1546 which in some embodiments couple to processor 1510 via a system management bus (SMBus) bus.

Using the various inertial and environmental sensors present in a platform, many different use cases may be realized. These use cases enable advanced computing operations including perceptual computing and also allow for enhancements with regard to power management/battery life, security, and system responsiveness.

For example with regard to power management/battery life issues, based at least on part on information from an ambient light sensor, the ambient light conditions in a location of the platform are determined and intensity of the display controlled accordingly. Thus, power consumed in operating the display is reduced in certain light conditions.

As to security operations, based on context information obtained from the sensors such as location information, it may be determined whether a user is allowed to access certain secure documents. For example, a user may be permitted to access such documents at a work place or a home location. However, the user is prevented from accessing such documents when the platform is present at a public location. This determination, in one embodiment, is based on location information, e.g., determined via a GPS sensor or camera recognition of landmarks. Other security operations may include providing for pairing of devices within a close range of each other, e.g., a portable platform as described herein and a user's desktop computer, mobile telephone or so forth. Certain sharing, in some implementations, are realized via near field communication when these devices are so paired. However, when the devices exceed a certain range, such sharing may be disabled. Furthermore, when pairing a platform as described herein and a smartphone, an alarm may be configured to be triggered when the devices move more than a predetermined distance from each other, when in a public location. In contrast, when these paired devices are in a safe location, e.g., a work place or home location, the devices may exceed this predetermined limit without triggering such alarm.

Responsiveness may also be enhanced using the sensor information. For example, even when a platform is in a low power state, the sensors may still be enabled to run at a relatively low frequency. Accordingly, any changes in a location of the platform, e.g., as determined by inertial sensors, GPS sensor, or so forth is determined. If no such changes have been registered, a faster connection to a previous wireless hub such as a Wi-Fi™ access point or similar wireless enabler occurs, as there is no need to scan for available wireless network resources in this case. Thus, a greater level of responsiveness when waking from a low power state is achieved.

It is to be understood that many other use cases may be enabled using sensor information obtained via the integrated sensors within a platform as described herein, and the above examples are only for purposes of illustration. Using a system as described herein, a perceptual computing system may allow for the addition of alternative input modalities, including gesture recognition, and enable the system to sense user operations and intent.

In some embodiments one or more infrared or other heat sensing elements, or any other element for sensing the presence or movement of a user may be present. Such sensing elements may include multiple different elements working together, working in sequence, or both. For example, sensing elements include elements that provide initial sensing, such as light or sound projection, followed by sensing for gesture detection by, for example, an ultrasonic time of flight camera or a patterned light camera.

Also in some embodiments, the system includes a light generator to produce an illuminated line. In some embodiments, this line provides a visual cue regarding a virtual boundary, namely an imaginary or virtual location in space, where action of the user to pass or break through the virtual boundary or plane is interpreted as an intent to engage with the computing system. In some embodiments, the illuminated line may change colors as the computing system transitions into different states with regard to the user. The illuminated line may be used to provide a visual cue for the user of a virtual boundary in space, and may be used by the system to determine transitions in state of the computer with regard to the user, including determining when the user wishes to engage with the computer.

In some embodiments, the computer senses user position and operates to interpret the movement of a hand of the user through the virtual boundary as a gesture indicating an intention of the user to engage with the computer. In some embodiments, upon the user passing through the virtual line or plane the light generated by the light generator may change, thereby providing visual feedback to the user that the user has entered an area for providing gestures to provide input to the computer.

Display screens may provide visual indications of transitions of state of the computing system with regard to a user. In some embodiments, a first screen is provided in a first state in which the presence of a user is sensed by the system, such as through use of one or more of the sensing elements.

In some implementations, the system acts to sense user identity, such as by facial recognition. Here, transition to a second screen may be provided in a second state, in which the computing system has recognized the user identity, where this second the screen provides visual feedback to the user that the user has transitioned into a new state. Transition to a third screen may occur in a third state in which the user has confirmed recognition of the user.

In some embodiments, the computing system may use a transition mechanism to determine a location of a virtual boundary for a user, where the location of the virtual boundary may vary with user and context. The computing system may generate a light, such as an illuminated line, to indicate the virtual boundary for engaging with the system. In some embodiments, the computing system may be in a waiting state, and the light may be produced in a first color. The computing system may detect whether the user has reached past the virtual boundary, such as by sensing the presence and movement of the user using sensing elements.

In some embodiments, if the user has been detected as having crossed the virtual boundary (such as the hands of the user being closer to the computing system than the virtual boundary line), the computing system may transition to a state for receiving gesture inputs from the user, where a mechanism to indicate the transition may include the light indicating the virtual boundary changing to a second color.

In some embodiments, the computing system may then determine whether gesture movement is detected. If gesture movement is detected, the computing system may proceed with a gesture recognition process, which may include the use of data from a gesture data library, which may reside in memory in the computing device or may be otherwise accessed by the computing device.

If a gesture of the user is recognized, the computing system may perform a function in response to the input, and return to receive additional gestures if the user is within the virtual boundary. In some embodiments, if the gesture is not recognized, the computing system may transition into an error state, where a mechanism to indicate the error state may include the light indicating the virtual boundary changing to a third color, with the system returning to receive additional gestures if the user is within the virtual boundary for engaging with the computing system.

As mentioned above, in other embodiments the system can be configured as a convertible tablet system that can be used in at least two different modes, a tablet mode and a notebook mode. The convertible system may have two panels, namely a display panel and a base panel such that in the tablet mode the two panels are disposed in a stack on top of one another. In the tablet mode, the display panel faces outwardly and may provide touch screen functionality as found in conventional tablets. In the notebook mode, the two panels may be arranged in an open clamshell configuration.

In various embodiments, the accelerometer may be a 3-axis accelerometer having data rates of at least 50 Hz. A gyroscope may also be included, which can be a 3-axis gyroscope. In addition, an e-compass/magnetometer may be present. Also, one or more proximity sensors may be provided (e.g., for lid open to sense when a person is in proximity (or not) to the system and adjust power/performance to extend battery life). For some OS's Sensor Fusion capability including the accelerometer, gyroscope, and compass may provide enhanced features. In addition, via a sensor hub having a real-time clock (RTC), a wake from sensors mechanism may be realized to receive sensor input when a remainder of the system is in a low power state.

In some embodiments, an internal lid/display open switch or sensor to indicate when the lid is closed/open, and can be used to place the system into Connected Standby or automatically wake from Connected Standby state. Other system sensors can include ACPI sensors for internal processor, memory, and skin temperature monitoring to enable changes to processor and system operating states based on sensed parameters.

In an embodiment, the OS may be a Microsoft® Windows® 8 OS that implements Connected Standby (also referred to herein as Windows CS). Windows 8 Connected Standby or another OS having a similar state can provide, via a platform as described herein, very low ultra idle power to enable applications to remain connected, e.g., to a cloud-based location, at very low power consumption. The platform can supports 3 power states, namely screen on (normal); Connected Standby (as a default “off” state); and shutdown (zero watts of power consumption). Thus in the Connected Standby state, the platform is logically on (at minimal power levels) even though the screen is off. In such a platform, power management can be made to be transparent to applications and maintain constant connectivity, in part due to offload technology to enable the lowest powered component to perform an operation.

Also seen in FIG. 15, various peripheral devices may couple to processor 1510 via a low pin count (LPC) interconnect. In the embodiment shown, various components can be coupled through an embedded controller (EC) 1535. Such components can include a keyboard 1536 (e.g., coupled via a PS2 interface), a fan 1537, and a thermal sensor 1539. In some embodiments, touch pad 1530 may also couple to EC 1535 via a PS2 interface. In addition, a security processor such as a trusted platform module (TPM) 1538 in accordance with the Trusted Computing Group (TCG) TPM Specification Version 1.2, dated Oct. 2, 2003, may also couple to processor 1510 via this LPC interconnect. However, understand the scope of the present disclosure is not limited in this regard and secure processing and storage of secure information may be in another protected location such as a static random access memory (SRAM) in a security coprocessor, or as encrypted data blobs that are only decrypted when protected by a secure enclave (SE) processor mode.

In a particular implementation, peripheral ports may include a high definition media interface (HDMI) connector (which can be of different form factors such as full size, mini or micro); one or more USB ports, such as full-size external ports in accordance with a Universal Serial Bus specification, with at least one powered for charging of USB devices (such as smartphones) when the system is in Connected Standby state and is plugged into AC wall power. In addition, one or more Thunderbolt™ ports can be provided. Other ports may include an externally accessible card reader such as a full size SD-XC card reader and/or a SIM card reader for WWAN (e.g., an 8 pin card reader). For audio, a 3.5 mm jack with stereo sound and microphone capability (e.g., combination functionality) can be present, with support for jack detection (e.g., headphone only support using microphone in the lid or headphone with microphone in cable). In some embodiments, this jack can be re-taskable between stereo headphone and stereo microphone input. Also, a power jack can be provided for coupling to an AC brick.

System 1500 can communicate with external devices in a variety of manners, including wirelessly. In the embodiment shown in FIG. 15, various wireless modules, each of which can correspond to a radio configured for a particular wireless communication protocol, are present. One manner for wireless communication in a short range such as a near field may be via a near field communication (NFC) unit 1545 which may communicate, in one embodiment with processor 1510 via an SMBus. Note that via this NFC unit 1545, devices in close proximity to each other can communicate. For example, a user can enable system 1500 to communicate with another (e.g.,) portable device such as a smartphone of the user via adapting the two devices together in close relation and enabling transfer of information such as identification information payment information, data such as image data or so forth. Wireless power transfer may also be performed using a NFC system.

Using the NFC unit described herein, users can bump devices side-to-side and place devices side-by-side for near field coupling functions (such as near field communication and wireless power transfer (WPT)) by leveraging the coupling between coils of one or more of such devices. More specifically, embodiments provide devices with strategically shaped, and placed, ferrite materials, to provide for better coupling of the coils. Each coil has an inductance associated with it, which can be chosen in conjunction with the resistive, capacitive, and other features of the system to enable a common resonant frequency for the system.

As further seen in FIG. 15, additional wireless units can include other short range wireless engines including a WLAN unit 1550 and a Bluetooth unit 1552. Using WLAN unit 1550, Wi-Fi™ communications in accordance with a given Institute of Electrical and Electronics Engineers (IEEE) 802.11 standard can be realized, while via Bluetooth unit 1552, short range communications via a Bluetooth protocol can occur. These units may communicate with processor 1510 via, e.g., a USB link or a universal asynchronous receiver transmitter (UART) link. Or these units may couple to processor 1510 via an interconnect according to a Peripheral Component Interconnect Express™ (PCIe™) protocol, e.g., in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the NGFF connectors adapted to a motherboard.

In addition, wireless wide area communications, e.g., according to a cellular or other wireless wide area protocol, can occur via a WWAN unit 1556 which in turn may couple to a subscriber identity module (SIM) 1557. In addition, to enable receipt and use of location information, a GPS module 1555 may also be present. Note that in the embodiment shown in FIG. 15, WWAN unit 1556 and an integrated capture device such as a camera module 1554 may communicate via a given USB protocol, e.g., USB 2.0 or 3.0 link, or a UART or I²C protocol. Again the actual physical connection of these units can be via adaptation of a NGFF add-in card to an NGFF connector configured on the motherboard.

In a particular embodiment, wireless functionality can be provided modularly, e.g., with a WiFi™ 802.11ac solution (e.g., add-in card that is backward compatible with IEEE 802.11abgn) with support for Windows 8 CS. This card can be configured in an internal slot (e.g., via an NGFF adapter). An additional module may provide for Bluetooth capability (e.g., Bluetooth 4.0 with backwards compatibility) as well as Intel® Wireless Display functionality. In addition NFC support may be provided via a separate device or multi-function device, and can be positioned as an example, in a front right portion of the chassis for easy access. A still additional module may be a WWAN device that can provide support for 3G/4G/LTE and GPS. This module can be implemented in an internal (e.g., NGFF) slot. Integrated antenna support can be provided for WiFi™, Bluetooth, WWAN, NFC and GPS, enabling seamless transition from WiFi™ to WWAN radios, wireless gigabit (WiGig) in accordance with the Wireless Gigabit Specification (July 2010), and vice versa.

As described above, an integrated camera can be incorporated in the lid. As one example, this camera can be a high resolution camera, e.g., having a resolution of at least 2.0 megapixels (MP) and extending to 6.0 MP and beyond.

To provide for audio inputs and outputs, an audio processor can be implemented via a digital signal processor (DSP) 1560, which may couple to processor 1510 via a high definition audio (HDA) link. Similarly, DSP 1560 may communicate with an integrated coder/decoder (CODEC) and amplifier 1562 that in turn may couple to output speakers 1563 which may be implemented within the chassis. Similarly, amplifier and CODEC 1562 can be coupled to receive audio inputs from a microphone 1565 which in an embodiment can be implemented via dual array microphones (such as a digital microphone array) to provide for high quality audio inputs to enable voice-activated control of various operations within the system. Note also that audio outputs can be provided from amplifier/CODEC 1562 to a headphone jack 1564. Although shown with these particular components in the embodiment of FIG. 15, understand the scope of the present disclosure is not limited in this regard.

In a particular embodiment, the digital audio codec and amplifier are capable of driving the stereo headphone jack, stereo microphone jack, an internal microphone array and stereo speakers. In different implementations, the codec can be integrated into an audio DSP or coupled via an HD audio path to a peripheral controller hub (PCH). In some implementations, in addition to integrated stereo speakers, one or more bass speakers can be provided, and the speaker solution can support DTS audio.

In some embodiments, processor 1510 may be powered by an external voltage regulator (VR) and multiple internal voltage regulators that are integrated inside the processor die, referred to as fully integrated voltage regulators (FIVRs). The use of multiple FIVRs in the processor enables the grouping of components into separate power planes, such that power is regulated and supplied by the FIVR to only those components in the group. During power management, a given power plane of one FIVR may be powered down or off when the processor is placed into a certain low power state, while another power plane of another FIVR remains active, or fully powered.

In one embodiment, a sustain power plane can be used during some deep sleep states to power on the I/O pins for several I/O signals, such as the interface between the processor and a PCH, the interface with the external VR and the interface with EC 1535. This sustain power plane also powers an on-die voltage regulator that supports the on-board SRAM or other cache memory in which the processor context is stored during the sleep state. The sustain power plane is also used to power on the processor's wakeup logic that monitors and processes the various wakeup source signals.

During power management, while other power planes are powered down or off when the processor enters certain deep sleep states, the sustain power plane remains powered on to support the above-referenced components. However, this can lead to unnecessary power consumption or dissipation when those components are not needed. To this end, embodiments may provide a connected standby sleep state to maintain processor context using a dedicated power plane. In one embodiment, the connected standby sleep state facilitates processor wakeup using resources of a PCH which itself may be present in a package with the processor. In one embodiment, the connected standby sleep state facilitates sustaining processor architectural functions in the PCH until processor wakeup, this enabling turning off all of the unnecessary processor components that were previously left powered on during deep sleep states, including turning off all of the clocks. In one embodiment, the PCH contains a time stamp counter (TSC) and connected standby logic for controlling the system during the connected standby state. The integrated voltage regulator for the sustain power plane may reside on the PCH as well.

In an embodiment, during the connected standby state, an integrated voltage regulator may function as a dedicated power plane that remains powered on to support the dedicated cache memory in which the processor context is stored such as critical state variables when the processor enters the deep sleep states and connected standby state. This critical state may include state variables associated with the architectural, micro-architectural, debug state, and/or similar state variables associated with the processor.

The wakeup source signals from EC 1235 may be sent to the PCH instead of the processor during the connected standby state so that the PCH can manage the wakeup processing instead of the processor. In addition, the TSC is maintained in the PCH to facilitate sustaining processor architectural functions. Although shown with these particular components in the embodiment of FIG. 12, understand the scope of the present disclosure is not limited in this regard.

Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

Some implementations may provide a specific power management IC (PMIC) to control platform power. Using this solution, a system may see very low (e.g., less than 5%) battery degradation over an extended duration (e.g., 16 hours) when in a given standby state, such as when in a Windows Connected Standby state. In a Windows idle state a battery life exceeding, e.g., 9 hours may be realized (e.g., at 150 nits). As to video playback, a long battery life can be realized, e.g., full HD video playback can occur for a minimum of 6 hours. A platform in one implementation may have an energy capacity of, e.g., 35 watt hours (Whr) for a Windows CS using an SSD and (e.g.,) 40-44 Whr for Windows CS using an HDD with a RST cache configuration.

A particular implementation may provide support for 15 W nominal CPU thermal design power (TDP), with a configurable CPU TDP of up to approximately 25 W TDP design point. The platform may include minimal vents owing to the thermal features described above. In addition, the platform is pillow-friendly (in that no hot air is blowing at the user). Different maximum temperature points can be realized depending on the chassis material. In one implementation of a plastic chassis (at least having to lid or base portion of plastic), the maximum operating temperature can be 52 degrees Celsius (C). And for an implementation of a metal chassis, the maximum operating temperature can be 46° C.

In different implementations, a security module such as a TPM can be integrated into a processor or can be a discrete device such as a TPM 2.0 device. With an integrated security module, also referred to as Platform Trust Technology (PTT), BIOS/firmware can be enabled to expose certain hardware features for certain security features, including secure instructions, secure boot, Intel® Anti-Theft Technology, Intel® Identity Protection Technology, Intel® Trusted Execution Technology (TXT), and Intel® Manageability Engine Technology along with secure user interfaces such as a secure keyboard and display.

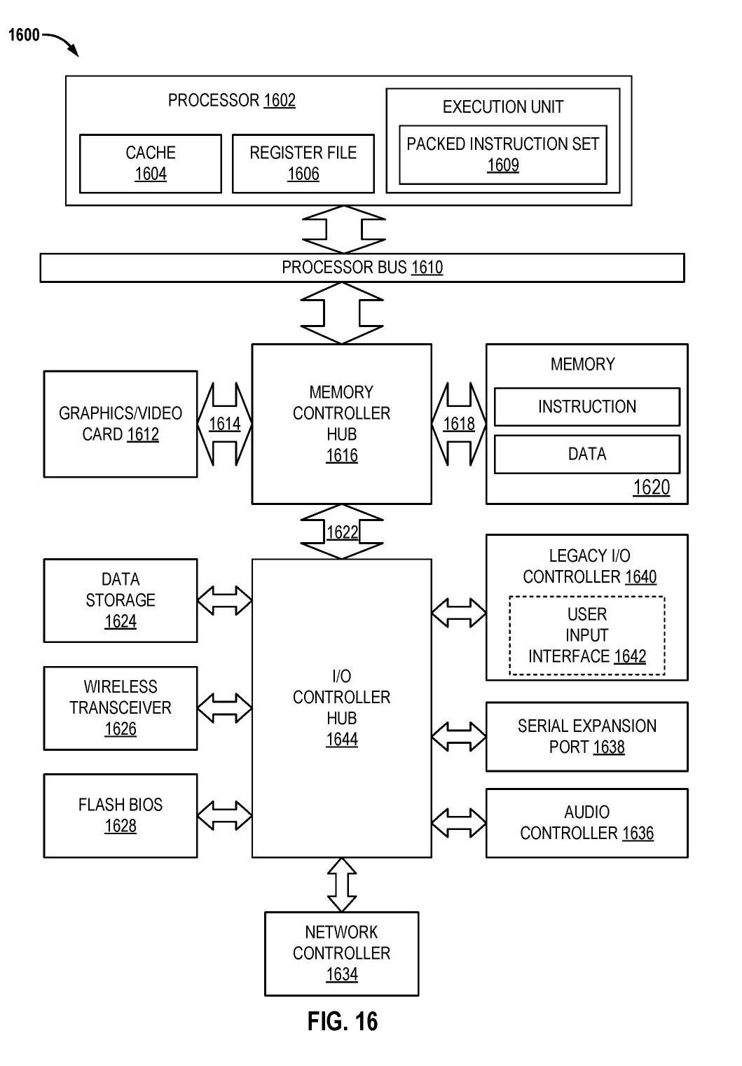

Turning to FIG. 16, a block diagram of an exemplary computer system formed with a processor that includes execution units to execute an instruction, where one or more of the interconnects implement one or more features in accordance with embodiments of the disclosure is illustrated. System 1600 includes a component, such as a processor 1602 to employ execution units including logic to perform algorithms for process data, in accordance with the present disclosure, such as in the embodiment described herein. System 1600 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 1600 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 1602 includes one or more execution units 1608 to implement an algorithm that is to perform at least one instruction. One embodiment may be described in the context of a single processor desktop or server system, but alternative embodiments may be included in a multiprocessor system. System 1600 is an example of a ‘hub’ system architecture. The computer system 1600 includes a processor 1602 to process data signals. The processor 1602, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 1602 is coupled to a processor bus 1610 that transmits data signals between the processor 1602 and other components in the system 1600. The elements of system 1600 (e.g. graphics accelerator 1612, memory controller hub 2016, memory 1620, I/O controller hub 1644, wireless transceiver 1626, Flash BIOS 1628, Network controller 1634, Audio controller 1636, Serial expansion port 1638, I/O controller 1640, etc.) perform their conventional functions that are well known to those familiar with the art.

In one embodiment, the processor 1602 includes a Level 1 (L1) internal cache memory 1604. Depending on the architecture, the processor 1602 may have a single internal cache or multiple levels of internal caches. Other embodiments include a combination of both internal and external caches depending on the particular implementation and needs. Register file 1606 is to store different types of data in various registers including integer registers, floating point registers, vector registers, banked registers, shadow registers, checkpoint registers, status registers, and instruction pointer register.

Execution unit 1608, including logic to perform integer and floating point operations, also resides in the processor 1602. The processor 1602, in one embodiment, includes a microcode (μcode) ROM to store microcode, which when executed, is to perform algorithms for certain macroinstructions or handle complex scenarios. Here, microcode is potentially updateable to handle logic bugs/fixes for processor 1602. For one embodiment, execution unit 1608 includes logic to handle a packed instruction set 1609. By including the packed instruction set 1609 in the instruction set of a general-purpose processor 1602, along with associated circuitry to execute the instructions, the operations used by many multimedia applications may be performed using packed data in a general-purpose processor 1602. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 1608 may also be used in micro controllers, embedded processors, graphics devices, DSPs, and other types of logic circuits. System 1600 includes a memory 1620. Memory 1620 includes a dynamic random access memory (DRAM) device, a static random access memory (SRAM) device, flash memory device, or other memory device. Memory 1620 stores instructions and/or data represented by data signals that are to be executed by the processor 1602.

Note that any of the aforementioned features or aspects of the embodiments of the disclosure may be utilized on one or more interconnect illustrated in FIG. 16. For example, an on-die interconnect (ODI), which is not shown, for coupling internal units of processor 1602 implements one or more aspects of the disclosure herein. Or the embodiments of the disclosure are associated with a processor bus 1610 (e.g. Intel Quick Path Interconnect (QPI) or other known high performance computing interconnect), a high bandwidth memory path 1618 to memory 1620, a point-to-point link 1614 to graphics accelerator 1612 (e.g. a Peripheral Component Interconnect express (PCIe) compliant fabric), a controller hub interconnect 1622, an I/O or other interconnect (e.g. USB, PCI, PCIe) for coupling the other illustrated components. Some examples of such components include the audio controller 1636, firmware hub (flash BIOS) 1628, wireless transceiver 1626, data storage 1624, legacy I/O controller 1610 containing user input and keyboard interfaces 1642, a serial expansion port 1638 such as Universal Serial Bus (USB), and a network controller 1634. The data storage device 1624 can comprise a hard disk drive, a floppy disk drive, a CD-ROM device, a flash memory device, or other mass storage device.

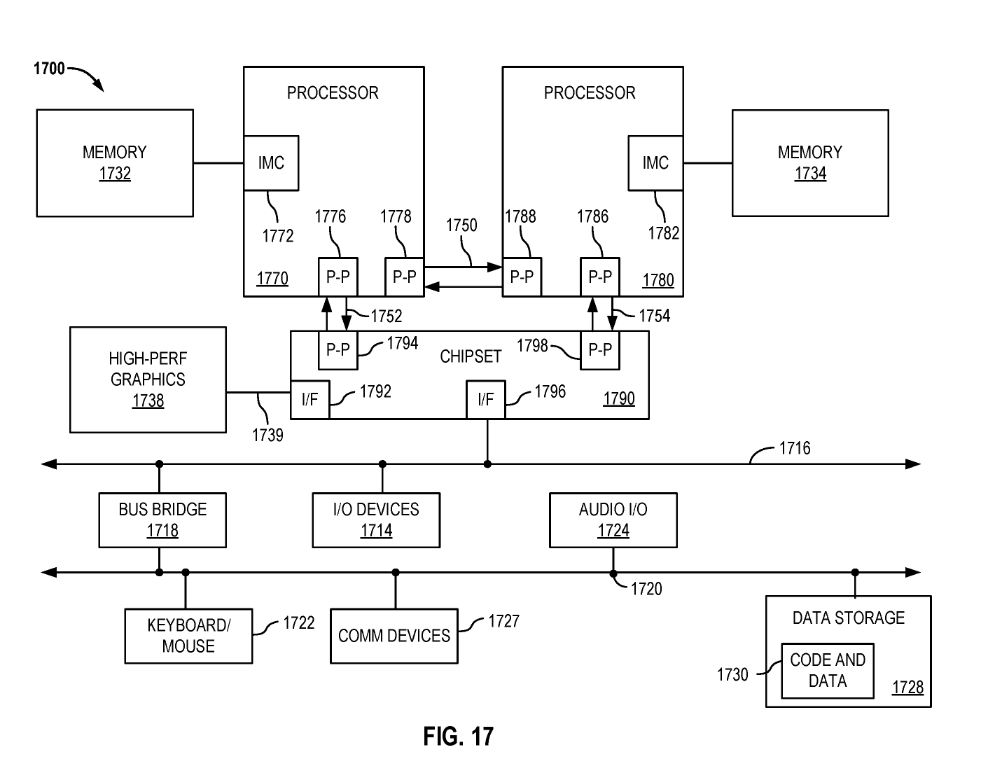

Referring now to FIG. 17, shown is a block diagram of a second system 1700 in accordance with an embodiment of the present disclosure. As shown in FIG. 17, multiprocessor system 1700 is a point-to-point interconnect system, and includes a first processor 1770 and a second processor 1780 coupled via a point-to-point interconnect 1750. Each of processors 1770 and 1780 may be some version of a processor. In one embodiment, 1752 and 1754 are part of a serial, point-to-point coherent interconnect fabric, such as Intel's Quick Path Interconnect (QPI) architecture. As a result, embodiments of the disclosure may be implemented within the QPI architecture.

While shown with only two processors 1770, 1780, it is to be understood that the scope of the present disclosure is not so limited. In other embodiments, one or more additional processors may be present in a given processor.

Processors 1770 and 1780 are shown including integrated memory controller units 1772 and 1782, respectively. Processor 1770 also includes as part of its bus controller units point-to-point (P-P) interfaces 1776 and 1778; similarly, second processor 1780 includes P-P interfaces 1786 and 1788. Processors 1770, 1780 may exchange information via a point-to-point (P-P) interface 1750 using P-P interface circuits 1778, 1788. As shown in FIG. 17, IMCs 1772 and 1782 couple the processors to respective memories, namely a memory 1732 and a memory 1734, which may be portions of main memory locally attached to the respective processors.

Processors 1770, 1780 each exchange information with a chipset 1790 via individual P-P interfaces 1752, 1754 using point to point interface circuits 1776, 1794, 1786, 1798. Chipset 1790 also exchanges information with a high-performance graphics circuit 1738 via an interface circuit 1792 along a high-performance graphics interconnect 1739.

A shared cache (not shown) may be included in either processor or outside of both processors; yet connected with the processors via P-P interconnect, such that either or both processors' local cache information may be stored in the shared cache if a processor is placed into a low power mode.

Chipset 1790 may be coupled to a first bus 1716 via an interface 1796. In one embodiment, first bus 1716 may be a Peripheral Component Interconnect (PCI) bus, or a bus such as a PCI Express bus or another third generation I/O interconnect bus, although the scope of the present disclosure is not so limited.

As shown in FIG. 17, various I/O devices 1714 are coupled to first bus 1716, along with a bus bridge 1718 which couples first bus 1716 to a second bus 1720. In one embodiment, second bus 1720 includes a low pin count (LPC) bus. Various devices are coupled to second bus 1720 including, for example, a keyboard and/or mouse 1722, communication devices 1727 and a storage unit 1728 such as a disk drive or other mass storage device which often includes instructions/code and data 1730, in one embodiment. Further, an audio I/O 1724 is shown coupled to second bus 1720. Note that other architectures are possible, where the included components and interconnect architectures vary. For example, instead of the point-to-point architecture of FIG. 17, a system may implement a multi-drop bus or other such architecture.

Embodiments (e.g., of the mechanisms) disclosed herein may be implemented in hardware (e.g., a computer programmed to perform a method may be as described in the detailed description), software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be executed to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. The mechanisms described herein are not limited in scope to any particular programming language. The language may be a compiled or interpreted language.

One or more aspects of at least one embodiment may be implemented by representative instructions stored on a non-transitory, machine-readable medium which represents various logic within the processor, which when read by a machine causes the machine to fabricate logic to perform the techniques described herein. Such representations, which may be generally referred to as “IP cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

What is claimed is:

1. An apparatus comprising:
a serial bus hub to electrically couple a plurality of hosts and a plurality of devices; and
a circuit to spawn a first virtual hub instance that is bound to a first host of the plurality of hosts and a first device of the plurality of devices, and spawn a concurrently usable, second virtual hub instance that is bound to a second host of the plurality of hosts and a second device of the plurality of devices.

2. The apparatus of claim 1, wherein a third device of the plurality of devices is bound by the circuit to the first virtual hub instance with the first device.

3. The apparatus of claim 1, wherein a host of the plurality of hosts is to specify to the circuit a subset of the plurality of devices to be bound to a virtual hub instance.

4. The apparatus of claim 1, wherein a reset request from the first host is to cause a reset of the first virtual hub instance and not a reset of the second virtual hub instance.

5. The apparatus of claim 4, wherein the reset request from the first host is to not cause a reset of the serial bus hub.

6. The apparatus of claim 5, wherein the first virtual hub instance is to send back a response to the host indicating reset success of the serial bus hub.

7. The apparatus of claim 1, wherein the circuit is to present, to a subsequent host electrically coupled to the serial bus hub, a list of the plurality of devices that are not bound to a current virtual hub instance.

8. The apparatus of claim 1, wherein the first virtual hub instance is bound to the first host and the first device according to a Universal Serial Bus (USB) specification.

9. A method comprising:
electrically coupling a plurality of downstream facing ports and a plurality of upstream facing ports with a serial bus hub;
spawning a first virtual hub instance that is bound to a first downstream facing port of the plurality of downstream facing ports and a first upstream facing port of the plurality of upstream facing ports; and
spawning a concurrently usable, second virtual hub instance that is bound to a second downstream facing port of the plurality of downstream facing ports and a second upstream facing port of the plurality of upstream facing ports.

10. The method of claim 9, further comprising binding a third upstream facing port of the plurality of upstream facing ports to the first virtual hub instance having the first upstream facing port.

11. The method of claim 9, wherein a downstream facing port of the plurality of downstream facing ports specifies a subset of the plurality of upstream facing ports to be bound to a virtual hub instance.

12. The method of claim 9, wherein a reset request from the first downstream facing port causes a reset of the first virtual hub instance and not a reset of the second virtual hub instance.

13. The method of claim 12, wherein the reset request from the first downstream facing port does not cause a reset of the serial bus hub.

14. The method of claim 13, wherein the first virtual hub instance sends back a response to the first downstream facing port indicating reset success of the serial bus hub.

15. The method of claim 9, further comprising presenting, to a subsequent downstream facing port electrically coupled to the serial bus hub, a list of the plurality of upstream facing ports that are not bound to a current virtual hub instance.

16. The method of claim 9, wherein the first virtual hub instance is bound to the first downstream facing port and the first upstream facing port according to a Universal Serial Bus (USB) specification.

17. A non-transitory machine readable medium that stores code that when executed by a machine causes the machine to perform a method comprising:
electrically coupling a plurality of downstream facing ports and a plurality of upstream facing ports with a serial bus hub;
spawning a first virtual hub instance that is bound to a first downstream facing port of the plurality of downstream facing ports and a first upstream facing port of the plurality of upstream facing ports; and
spawning a concurrently usable, second virtual hub instance that is bound to a second downstream facing port of the plurality of downstream facing ports and a second upstream facing port of the plurality of upstream facing ports.

18. The non-transitory machine readable medium of claim 17, wherein the method further comprises binding a third upstream facing port of the plurality of upstream facing ports to the first virtual hub instance having the first upstream facing port.

19. The non-transitory machine readable medium of claim 17, wherein a downstream facing port of the plurality of downstream facing ports specifies a subset of the plurality of upstream facing ports to be bound to a virtual hub instance.

20. The non-transitory machine readable medium of claim 17, wherein a reset request from the first downstream facing port causes a reset of the first virtual hub instance and not a reset of the second virtual hub instance.

21. The non-transitory machine readable medium of claim 20, wherein the reset request from the first downstream facing port does not cause a reset of the serial bus hub.

22. The non-transitory machine readable medium of claim 21, wherein the first virtual hub instance sends back a response to the first downstream facing port indicating reset success of the serial bus hub.

23. The non-transitory machine readable medium of claim 17, wherein the method further comprises presenting, to a subsequent downstream facing port electrically coupled to the serial bus hub, a list of the plurality of upstream facing ports that are not bound to a current virtual hub instance.

24. The non-transitory machine readable medium of claim 17, wherein the first virtual hub instance is bound to the first downstream facing port and the first upstream facing port according to a Universal Serial Bus (USB) specification.
